(19) United States
(12) Patent Application Publication
(10) Pub. No.: US 2026/0048966 A1
(43) Pub. Date: Feb. 19, 2026

(54) CRANE SYSTEM

(71) Applicant: GOGOH CO., LTD., Kasugai-shi (JP)

(72) Inventors: Kouji OGAWA, Aichi (JP); Teruhiko SAWADA, Aichi (JP)

(21) Appl. No.: 19/370,043

(22) Filed: Oct. 27, 2025

Related U.S. Application Data
(63) Continuation of application No. PCT/JP2023/016801, filed on Apr. 28, 2023.

(51) Int. Cl. B66C 13/40; B66C 13/46

(52) U.S. Cl. CPC B66C 13/40; B66C 13/46

(57) ABSTRACT

A display is attached to a hand-held controller for operating an overhead crane. When an operator operates the crane using the controller, a system control device for a crane system acquires operation details such as instructions on the direction of movement from the controller, as well as position information from mobile terminals of workers other than the operator who are within the facility. Then, the display displays information to assist in the operation of the crane, such as an arrow indicating the direction of movement of the crane and the positions of the workers. By displaying the direction of movement on the display, the operator can easily notice when the crane is directed in the wrong direction, while by displaying the positions of the workers, the risk of coming into contact with them can be avoided, whereby the safety of the crane system can be improved.

### CLAIM OF PRIORITY

This application is a Continuation of International Patent Application No. PCT/JP2023/016801, filed on April, 28, 2023, which is hereby incorporated by reference.

### BACKGROUND OF THE INVENTION

### 1. Field of the Invention

### 2. Description of the Related Art

The present invention relates to a crane system for moving a load.

In facilities such as factories and warehouses, cranes are used for transporting heavy objects. In order to improve efficiency during crane operation and prevent accidents, it is preferable to provide as much information as possible to the crane operator. JP2018-095362A discloses a technology for displaying a three-dimensional map showing the terrain, buildings, or the like around the work area on a display installed in the driver's seat of a crane truck. JP2019-156533A discloses a technology in which a camera is attached to the end of the boom of a crane truck and an image of a load captured by this camera is displayed on a display installed in the driver's seat. JP2000-191274A discloses a technology in which an indicator indicating the current east-west and north-south positions of a hoist is provided in a controller of an overhead crane. JP2016-136192A discloses a technology for mounting a display device on the hoist of an overhead crane to indicate the hoist's direction of movement.

However, in crane systems such as overhead cranes that are operated by a controller held by the operator, sufficient information was not being presented to the operator. One method is to attach a display device to the hoist, but in this case the operator must look up at the display device, which is located high up, while also checking the controller in hand, making operation difficult. This problem is not limited to overhead cranes, but is a common problem with crane systems that are operated by a controller held in the operator's hand. The object of the present invention is to provide sufficient information to an operator in a crane system that is operated by a controller held in the operator's hand.

In accordance with one embodiment of the present invention, a crane system comprises (a) a crane device for lifting and moving a load, (b) a controller that an operator holds in his or her hand to control the movement of the crane device, (c) a display unit attached to the controller that displays information about the crane device in the form of text and/or images, and (d) a display control unit that controls the display content of the display unit.

In accordance with the embodiment of the present invention, the display unit is attached to a controller operated by an operator, and information about the crane device is displayed on the display unit in the form of text, images, etc. Therefore, the operator can obtain information about the crane device from this display, which makes it possible to improve the efficiency of operating the crane device and prevent accidents.

Furthermore, in accordance with the embodiment of the present invention, since the display unit is provided on the controller, there is an advantage that the operator can easily see both the controller and the display unit. In the past, there have been examples of crane device being equipped with alarm devices that display the direction of movement (moving direction) and output sound, which have been effective in improving safety. However, if, for example, a load sways in front of the operator while operating a crane, the operators must concentrate on the load in front of them, making it very difficult for them to check the alarm device installed on the ceiling. In this regard, in the present invention, a display unit is provided on the controller, so the operator can check the display without having to move their line of sight significantly, thereby further improving safety.

The present invention can be applied to various crane devices, but may also be applied, for example, to an overhead crane that moves on a traveling rail installed in a factory or other facility in response to the operation of an operator.

Various types of controllers are also applicable. Instructions to the crane device may be given either by wire or wirelessly. Various types of controllers can be used, such as those operated by push buttons for north, south, east, and west directions, those that indicate the direction of movement by a relatively rotating cylinder, and those that indicate the direction of movement by a joystick.

The display unit can take various forms, such as a built-in type that is pre-installed in the controller, a type that is detachable from the controller, or a type that uses part of the operation unit of the controller as the display unit. For example, a mobile terminal such as a smartphone may be used as the display unit. However, the display unit must be capable of displaying characters and images, and does not include simple indicators. The display control unit can be provided in various forms, such as inside the controller, in the display unit, or in the crane device.

The content displayed on the display unit is information relating to the crane device. For example, information such as the position of the crane device, the direction of movement, the speed, winding up/winding down, whether or not a load is suspended, and the operation details for the crane device are included.

In accordance with one embodiment of the present invention, the display control unit may acquire the controller operation and cause the display unit to display information corresponding to that operation.

For example, when a direction of movement (a moving direction, or a direction to move) is specified with the controller, the direction is displayed. With conventional controllers, even if the operator instructed the wrong direction of movement, the crane device would move in the wrong direction without the operator realizing it. However, according to the above aspect, the operator can confirm the direction of movement that he or she has instructed, thereby improving safety. The same applies to operations other than instructing the direction of movement, such as winding up and winding down.

Displaying operation-specific information in preview display before the crane device starts moving is preferable for safety reasons, but the timing is not limited to this.

The operation of the controller is possible in various ways. The display control unit may receive the operation signal directly from the controller, or may receive the operation signal indirectly via some kind of control device or the like.

When displaying information in accordance with an operation, the display unit may be provided with a detection unit that detects the direction in which the display unit is facing, and the display control unit may cause the display unit to display information in accordance with the direction in which the display unit is facing.

The direction means an orientation in which the display unit faces in a horizontal plane. For example, it may be expressed in terms of directions such as north, south, east, and west, or the like, or it may be expressed as an azimuth angle relative to a reference direction such as north. More precisely, the direction of the display unit is the direction of a vector obtained by rotating the normal of the surface on which information is displayed on the display unit by 180 degrees. This direction is, in other words, an orientation close to the line-of-sight vector when the operator views the display unit.

This allows the display to be presented in a manner that is intuitively easy for the operator to understand. For example, when a direction of movement such as "East" is specified and the display unit is facing "North," the moving direction is displayed taking that direction into account. An arrow could be displayed on the right of the display unit, or the word “East” could be displayed on the right of the display unit. This allows the operator to intuitively understand the direction of movement.

In accordance with another embodiment of the present invention, regardless of whether the direction of movement is displayed or not, the color or brightness of the screen may be changed depending on the direction of the display unit, so that the operator can intuitively understand which direction they are facing.

It should be noted that, in the present invention, the direction of movement does not necessarily have to be expressed as a direction. For example, various ways of expressing the direction can be used, such as front, back, left, right, mountain direction, sea direction, etc.

The direction of the display unit can be detected in various ways. In accordance with one embodiment of the present invention (a first aspect), the detection unit may include a sensor for detecting the direction of the display unit, and may output a result assigning the sensor's output to the closest preset predetermined direction.

For example, if the four directions of north, south, east, and west are set as the predetermined directions, and the accurate direction detected by the sensor is within a range of 45 degrees left and right of east, the display unit may output "East" as the direction. By allocating them to a predetermined direction in this way, the direction of the display unit can be identified with relatively light processing. Furthermore, by quantizing the direction of the display unit, offers the advantage of reducing the processing load required to display the direction.

The direction of the display unit only needs to be accurate enough for the operator to intuitively understand the displayed content, so even if the direction is assigned as in the first aspect, it is possible to provide a sufficiently useful display.

In the first aspect, the predetermined directions are not limited to the four directions of north, south, east, and west, and can be set arbitrarily. It is also not necessary to have an exact direction. For example, if the facility in which the crane system is installed is misaligned with the correct north-south-east-west directions, the north-south-east-west directions may be virtually set in accordance with the walls of the facility. In this case, it is sufficient to virtually assign directions within a predetermined range to each of the four directions of north, south, east, and west. Moreover, the range allocated to a predetermined direction does not necessarily have to be uniform. For example, the range allocated to the north-south direction may be wider than the range allocated to the east-west direction.

In accordance with another embodiment of the present invention (a second aspect), the detection unit may include a sensor for detecting the direction of the display unit, and the output of said sensor may be output after being corrected by a predetermined correction value.

As mentioned above, the facility in which the crane system is installed may be misaligned from its correct north-south-east-west direction, and the operator operating the crane often recognizes the north-south-east-west direction based on, for example, the walls of the facility. In such a case, if the display is made using the accurate direction, it may not match the operator's perception. Therefore, it is preferable to correct the direction detected by the sensor to an assumed direction within the facility. In the second aspect, the output of the sensor can be corrected using a preset correction value, so that the detection unit can provide an output that is consistent with the assumed direction used within the facility.

To explain more specifically. For example, consider a case where a facility with a rectangular shape is built at an angle of 10 degrees from the north-south-east-west directions. In this facility, the direction referred to as east-west is 10 degrees off from the exact east-west direction. For example, if the sensor outputs "East" as the direction of the display unit, the display unit is actually facing a direction that is 10 degrees off from the east-west direction within the facility. Therefore, displaying it as if the display unit is facing east, it will give the operator a sense of discomfort. In contrast to this, in the second mode, the sensor output is corrected by 10 degrees, so that a direction that is 10 degrees off east-west is output as the direction of the display unit. Although this is not an accurate direction, the output is consistent with the north, south, east, and west directions within the facility. Therefore, by applying this correction, it becomes possible to achieve a display that feels natural to the operator.

In the second aspect, the correction value may also be a value set based on the error between the direction set within the facility where the crane system is installed and the direction detected by the sensor.

This correction value can be obtained by performing calibration in advance. However, the correction value in the second aspect does not necessarily have to be accurately determined by calibration, but can also be set arbitrarily. For example, you may set the value through trial and error to achieve a display that feels natural to the operator.

In accordance with yet another embodiment of the present invention (a third aspect), the detection unit may detect a direction marker installed to indicate the direction within a facility in which the crane system is installed, and identify the direction of the display unit based on the direction marker.

In this way, the direction can be determined without using a sensor for detecting the direction. The direction marker may be a sign attached to the wall of the facility, or a line or figure drawn on the floor of the facility to indicate the direction. In the case of an overhead crane, the rails on which the crane device runs may be used as the direction marker. The detection unit may acquire an image of the direction marker by capturing it with a camera provided on the rear side of the display unit or by other means, and identify the direction by image processing or the like.

The direction marker does not need to be visible, and may be a beacon or other type of radio wave, laser, or sound wave. In such a case, the detection unit may identify the direction of the display unit based on the received signal.

In accordance with one embodiment of the present invention, the display control unit may cause the display unit to display the direction of movement of the crane device in a mode corresponding to the direction of the display unit.

This makes it possible to display the direction of movement in a manner that is intuitively easy for the operator to understand. The direction of movement may be displayed based on the operation of the controller, or may be displayed based on the actual movement of the crane device. Also, before the movement starts, the display may be based on the operation, and after the movement starts, the display may be based on the movement. This allows the operator to check his or her actual operation or the direction of movement of the crane device at hand, thereby improving safety.

When displaying the direction of movement, the display control unit may superimpose an image showing the state of the interior of a facility in which the crane system is

installed and an image showing the direction of movement of the crane device on the display unit.

This has the advantage that the direction of movement is displayed in an image corresponding to the scenery that the operator is viewing, making it easier for the operator to intuitively understand the direction of movement. Images of the inside of the facility can be generated in various ways. For example, a plan view (called a facility map) drawn based on two-dimensional data showing the arrangement of luggage and other items within the facility may be used. In this case, a map of the facility may be displayed according to the direction of the display unit, and an arrow indicating the direction of movement may be displayed two-dimensionally. Furthermore, the facility map may be drawn three-dimensionally using perspective projection or the like. The direction of movement may be depicted three-dimensionally alongside the facility map, or it may be depicted in the upper portion of the facility map.

Also, a three-dimensional image may be generated based on a three-dimensional model that represents the interior of the facility. In addition, images of the inside of the facility captured by a camera attached to the back of the display unit or the like may be used.

In the above embodiment, the display control unit may further cause the display unit to perform display according to an inclination of the display unit with respect to a horizontal plane.

For example, when the display unit is horizontal, a two-dimensional map of the facility is displayed, and when the display unit is tilted or vertical, a three-dimensional map of the facility is displayed according to the angle with respect to the horizontal plane. This allows for a more intuitive understanding of the displayed content. The same applies when the inside of a facility is displayed as a three-dimensional image or a captured image.

The angle with respect to the horizontal plane can be detected by a magnetic sensor, image analysis, or other various methods.

In accordance with one embodiment of the present invention, when it is determined that a danger has occurred, the display control unit may cause the display unit to display a warning to notify the operator operating the controller of the danger.

For example, a letter, color, or figure indicating danger may be displayed. Such a danger can be assessed in various ways. A signal indicating a "danger has occurred" may be received from the crane system control device. Position information of the crane device and position information of the controller may be detected, and the presence or absence of danger may be determined based on the distance and positional relationship between the two. The presence or absence of danger may be determined based on whether or not there is a person near the load, based on an image captured by a camera or the like provided on the back of the display unit or on the crane device.

In accordance with one embodiment of the present invention, the display control unit may cause the display unit to display a position of a person or object other than an operator operating the controller.

This makes it possible to avoid collisions with people or objects other than the operator. The position of a person other than the operator may be determined based on an image captured by a camera or the like provided on the back of the display unit or on the crane device.

Alternatively, a person other than the operator may carry a device capable of detecting position information, such as a GPS, and the position may be identified by its output. The position of an object other than the operator may also be determined based on an image captured by a camera or the like provided on the back of the display unit or on the crane device. Alternatively, the map may be stored in advance as a facility map.

In accordance with one embodiment of the present invention, the crane device may have a camera that captures the load from above, and the display control unit may cause the display unit to display an image captured by the camera.

This allows the operator to check the status of the load at hand. Therefore, abnormalities such as tilting or vibration of the load can be easily detected, improving safety.

In accordance with one embodiment of the present invention, the controller may further be capable of outputting sound.

This can further improve safety. The sounds that are output include the operation details performed by the controller, such as the direction of movement, and whether or not there is danger. Outputting sound from the controller has the advantage that it is easy to hear even in noisy environments.

Conventionally, there have been cases where an alarm device that outputs sound is installed on the crane device itself. However, in a facility where multiple crane devices are installed, each crane device outputs sound, so the operator may mistake the sound of the crane device he or she is operating for the sound of another crane device. However, according to the above aspect, since the voice is output from the controller, it is possible to avoid such mishearing, and it is possible to further improve safety.

In accordance with one embodiment of the present invention, the display unit may be detachable from the controller.

This has the advantage that the display unit can be easily replaced. The display unit may be a device dedicated to the crane system, or may be a general-purpose device such as a smartphone or other mobile terminal. The controller may be designed to operate only when the display unit is attached, or may be designed to operate regardless of whether the display unit is attached or not.

If the display unit is detachable, it is necessary to identify the display unit attached to the controller. Various methods can be used to identify the display, for example, in accordance with one embodiment of the present invention (a first aspect), the controller is given predetermined identification information, the display unit is capable of reading the identification information of the controller, and the display control unit associates the display unit with the controller by receiving the identification information from the display unit.

The identification information can be read, for example, by indicating the identification information in letters, numbers, etc. on the exterior surface of the controller, and then reading this information using an input unit such as a touch panel or keyboard provided on the display unit. Furthermore, identification information displayed on the exterior surface of the controller in the form of letters, numbers, barcodes, etc. may be read by the camera in the display unit. The identification information of the controller may be read through communication between the controller and the display unit.

In accordance with another embodiment of the present invention (a second aspect), the display unit may be given predetermined identification information, the controller may be capable of reading the identification information, and the display control unit may associate the display unit with the controller by receiving the identification information from the controller.

The identification information can be read, for example, by displaying letters and numbers on the outer surface of the display unit, and reading this using an input unit such as a touch panel or keyboard provided on the controller. Furthermore, identification information displayed on the outer surface of the display unit using letters, numbers, barcodes, etc. may be read by a camera or scanner attached to the controller. The identification information of the display unit may be read through communication between the controller and the display unit.

The display unit may be attached to the controller in a variety of ways and at various positions.

The controller may be mounted such that the display unit is positioned with its display surface facing forward, with the operation unit for controlling the crane device's movement located in front of said display unit.

This has the advantage that the display unit does not get in the way when operating the operation unit. The above-mentioned positional relationship can also be said to be a state in which the display unit is attached above the operation unit. The up and down directions of the controller can be defined by the state in which the controller is held in the hand for operation. Furthermore, if letters are written on the push buttons or other operation units, the up and down directions of the controller may be defined according to the orientation of the letters.

When the display unit is made detachable from the controller, the display unit may have a camera on its rear side, and the controller may be capable of mounting the display unit by tilting it in a direction such that the camera floats away from the mounting surface to which the display unit is attached, in accordance with one embodiment of the present invention.

When the display is in a horizontal position, the camera can only capture the floor. When using a camera mounted on the back of the display unit to capture pictures of the inside of a facility that uses a crane system, it is preferable to position the camera as upright as possible. On the other hand, when operating the controller while holding it in hands, it is easier to hold the controller at a slight angle from the horizontal.

In the above embodiment, the display unit is tilted relative to the controller, that is mounted at an angle to the controller. Therefore, when the controller is held at an angle, the display is closer to being vertical than the controller, allowing the camera to be used effectively.

In the above embodiment, the angle at which the camera is tilted can be determined arbitrarily. It is preferable that the display be at an angle such that it is vertical when the controller is held, but the angle is not limited to this.

When the display unit is detachable from the controller, the display unit may be attached to the controller via an attachment that is detachable from the controller, in accordance with one embodiment of the present invention. In this embodiment, not only the display unit but also the attachment itself is detachable. By doing this, it is possible to provide a display unit while using the existing controller.

The attachment may be attached to the controller, for example, by providing a mechanism in the base of the attachment that clamps a part of the controller body. When a wired controller is used, an attachment may be attached to the cable of the controller. Furthermore, both the controller and the attachment may be provided with a mechanism for attachment and detachment, such as a mechanism called a hot shoe for attaching a strobe or the like to a camera.

The attachment and the display unit may be configured as a single unit, or the attachment and the display unit may be detachable.

In accordance with one embodiment of the present invention, the display unit may be a mobile terminal, and the display control unit may cause the display to be performed on pre-registered mobile terminals that are located within a facility in which the crane device is installed or within a predetermined range in the vicinity thereof.

As mentioned above, in the present invention, a smartphone or other mobile terminal can be used as the display unit. In this case, it is conceivable that multiple mobile devices, such as the operator's own mobile terminal, could be used alternately as the display unit. Therefore, it is not necessarily the case that all of the mobile terminals that have been pre-registered in the crane system as display units are present within the facility.

In the above embodiment, the display is made on mobile terminals that are present within the facility or within a predetermined range in the vicinity thereof, so that unnecessary display can be suppressed. Furthermore, by suppressing the display, it is possible to prevent information such as the operating status of the crane system from leaking to the outside.

The determination of whether the display unit is present within a predetermined range within the facility or in the vicinity thereof may be made, for example, by acquiring position information of the display unit and making the determination based on this information. In addition, communication with the display unit may be performed using short-range communication, in which the communication distance is limited to within a specified distance range, so that communication is only established when the display unit is located within the facility or within a specified range nearby. In this way, the "predetermined range of vicinity" may be determined as a result.

In the above embodiment, multiple mobile terminals can be registered, at least one of the mobile terminals is attached to the controller, and the display control unit may cause one of the multiple registered mobile terminals attached to the controller to display different images than the other mobile terminals.

It may be displayed only on the display unit attached to the controller, but displaying it on other display units as well enables effective utilization of the mobile terminal.

According to the above aspect, the display content can be made different between the portable terminal attached to the controller and other mobile terminals, so that useful displays can be realized for each mobile terminal. If there are multiple mobile terminals that are not attached to the controller, different content may be displayed on each of them.

When a mobile terminal is used as the display unit, the display control unit may acquire position information of the mobile terminal and perform display according to the information, in accordance with one embodiment of the present invention.

By acquiring position information, it is possible to prevent mobile terminals located outside the facility from displaying content. Furthermore, the position information of the mobile terminal and the position information of the crane device may be acquired, and a warning message may be displayed as the crane device and the mobile terminal approach each other.

The position information of other mobile terminals may be acquired and the position may be displayed on the mobile terminal of the user. This allows the operator to know the position of others, improving safety. Also, by knowing the operator's position, other people can be careful not to collide with the crane device.

When a mobile terminal is used as the display unit, the display control unit may obtain the direction in which the mobile terminal is facing and perform display according to the direction, in accordance with one embodiment of the present invention.

This allows the operator to intuitively understand the direction of movement. Many mobile terminals are equipped with magnetic sensors, which can be used to easily obtain the direction. As explained above, the direction detected by the magnetic sensor may be assigned to one of the pre-quantized directions or may be corrected before use.

In accordance with one embodiment of the present invention, the display unit may also serve as an operation unit for operating the movement of the crane device.

For example, a possible mode is one in which the display terminal is a touch panel and the display screen is used for operation. The touch panel may display push buttons for north, south, east, and west, arrows indicating the direction of movement, and the like.

Furthermore, the surface of a push button provided on the controller may serve as the display unit. This allows the display of the push buttons to be changed to perform a variety of operations. For example, when the push button displays "up" to instruct winding up and "down" to instruct winding down, it is possible not to display instructions for the direction of movement such as north, south, east, and west. This makes it possible to avoid accidentally moving the crane device during winding up and winding down. Conversely, when the crane device is being moved, the "up" and "down" indications may not be displayed. By switching between displaying north, south, east, and west and displaying up and down, the push buttons can be used to give multiple instructions, improving safety and reducing the number of push buttons.

When the display unit and the operation unit are combined, it is not necessary to use the entire operation unit. A part of the operation unit may also serve as the display unit.

When the controller serves as both a display unit and an operation unit, the controller may have a first operation unit for instructing the direction of movement of the crane device and a second operation unit for instructing the start of movement, the display unit may be provided in the second operation unit, and the display control unit may display the operation results of the first operation unit on the display unit, in accordance with one embodiment of the present invention.

This allows the user to instruct the direction of movement and then to instruct the start of movement, thereby improving safety. Furthermore, the operation unit for instructing the start of movement displays the result of the instruction on the direction of movement. For example, when east is designated, "East" is displayed on the second operation unit. If the operator mistakenly points to west when he or she intended to point to east, the second operation unit displays "West," allowing the operator to notice the operation error before starting to move the crane device. In this way, the operator can start the movement of the crane device after confirming whether the instruction for the movement direction is correct, thereby improving safety.

The present invention does not necessarily have to have all of the above-mentioned features, and some of them may be omitted or combined as appropriate. Furthermore, the various functions realized in the aforementioned crane system may be configured as a method for controlling the crane system by a computer, or as a display method within the crane system. Alternatively, as described below, these methods may be configured as a computer program to be executed by a computer. Furthermore, the computer program may be configured as a computer-readable recording medium on which the computer program is recorded.

For example, the present invention may be a computer program for displaying information about the crane device on a mobile terminal in a crane system comprising (a) a crane device for lifting and moving a load, (b) a controller that an operator holds in his or her hand to operate the movement of the crane device, and (c) a system control device that controls the crane device in accordance with the operation, wherein the computer program realizes an acquisition function for acquiring information about the crane device from the system control device and a display function for displaying the acquired information as text and/or images.

The computer program is preferably run on a mobile terminal. By installing the computer program in a general-purpose mobile terminal such as a smartphone, it becomes possible to make it function as the display unit of the present invention. Alternatively, the computer program may run on a controller of the crane system.

In the computer program, the acquisition function may be a function of acquiring an operation of the controller, and the display function may be a function of causing a display according to the operation. Furthermore, the computer program may further include a detection function for detecting the direction in which the mobile terminal is facing, and the display function may be configured to cause the computer to perform a function for displaying information according to the direction. In addition, in the above computer program, the display function may be a function of superimposing an image showing the state of the interior of a facility in which the crane system is installed and an image showing the direction of movement of the crane device on the display unit.

### BRIEF DESCRIPTION OF THE DRAWINGS

The present invention is illustrated by way of example, and not by way of limitation, in the Figures of the accompanying drawings and in which like reference numerals refer to similar elements and in which:

FIG. 1 is an explanatory diagram showing the configuration of a crane system.

FIGS. 2A and 2B are explanatory diagrams showing the configuration of a controller.

FIG. 3 is an explanatory diagram showing the overview of a display during operation.

FIG. 4 is a flowchart of the display direction determination process (1).

FIG. 5 is a flowchart of the display direction determination process (2).

FIG. 6 is a flowchart of the display direction determination process (3).

FIG. 7 is a flowchart of the display process (operator).

FIGS. 8A through 8D are explanatory diagrams showing an example of a display screen of a display.

FIG. 9 is a flowchart of the display process (other than the operator).

FIG. 10 is an explanatory diagram showing the configuration of a controller in the second embodiment.

FIG. 11A is an explanatory diagram of the display registration process (1).

FIG. 11B is a flow chart of the display registration process (1).

FIG. 12A is an explanatory diagram of the display registration process (2).

FIG. 12B is a flow chart of the display registration process (2).

FIG. 13A is an explanatory diagram of the display registration process (3).

FIG. 13B is a flow chart of the display registration process (3).

FIG. 14 is an explanatory diagram showing the configuration of a controller in the third embodiment.

FIG. 15 is a flowchart of a preview display mode control process.

FIGS. 16A through 16C are explanatory diagrams showing the configuration of a controller in the fourth embodiment.

### DETAILED DESCRIPTION OF EMBODIMENTS OF THE INVENTION

The embodiments of the present invention will be described by taking as an example an overhead crane that transports heavy loads in a factory or warehouse. The present invention is not limited to this example and can be configured as various crane systems, and for example can also be configured as a patient lift for transporting patients. Crane systems are not limited to being installed indoors. Furthermore, the present invention is not necessarily limited to applications that move using fixed travel rails, such as overhead cranes.

The crane system of the embodiment will be described in the following order.

A. System Configuration:

B. Display Use Examples:

C. Display Direction Determination Process:

C1. Method 1:

C2. Method 2:

C3. Method 3:

D. Display Process:

E. Second Embodiment:

E1. Controller Configuration:

E2. Display Registration Process:

E2-1. Method 1:

E2-2. Method 2:

E2-3. Method 3:

F. Third Embodiment:

F1. Controller Configuration:

F2. Preview Display Mode Control Process:

G. Fourth Embodiment:

H. Effects and Examples of Variations:

A. System Configuration:

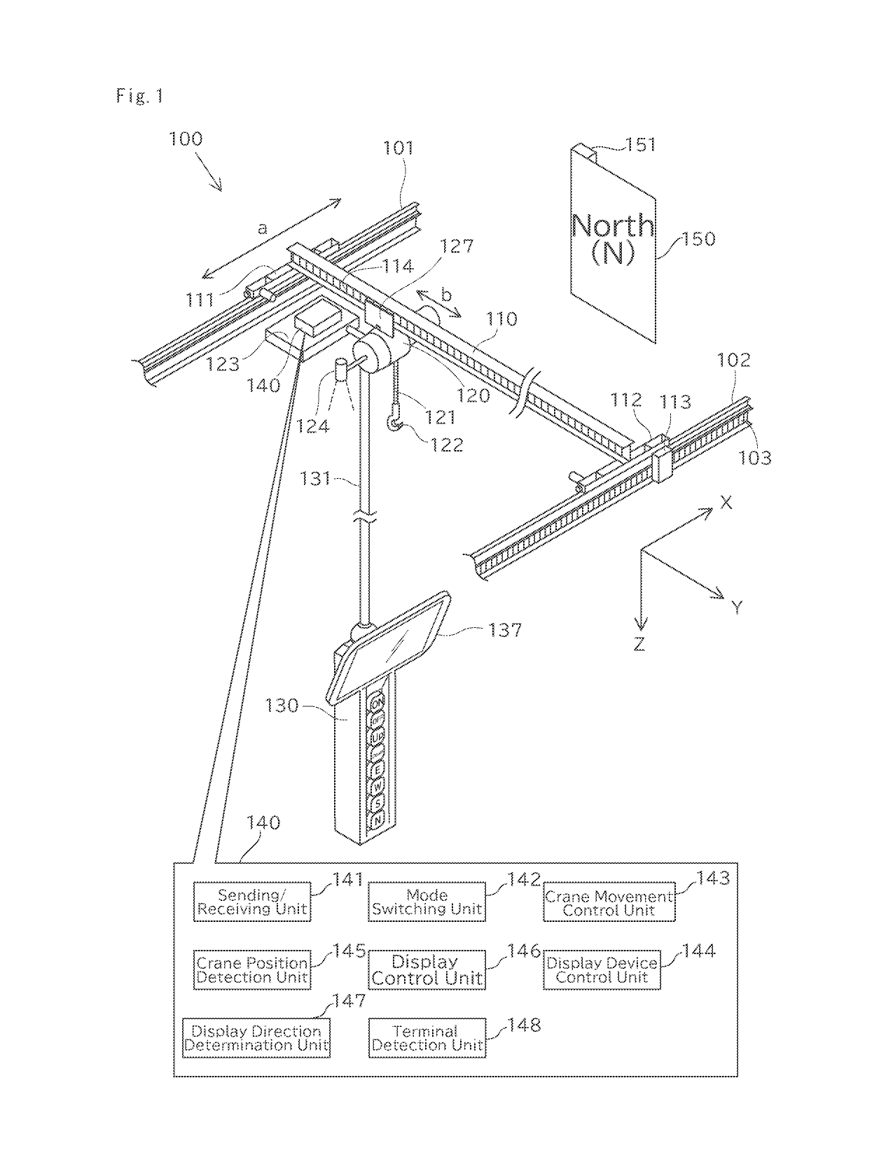

FIG. 1 is an explanatory diagram showing the configuration of a crane system. The overhead crane 100 is a device that moves on a traveling rail installed in a factory in response to the operation of a operator, and transports heavy objects. The overhead crane 100 is provided with a hoist 120, which is a lifting device for transporting a load. The hoist 120 can raise and lower a load by winding up and down a wire 121 having a hook 122 attached to the tip for hooking the load. Operations such as winding up or winding down the wire 121 in the hoist 120 and moving the hoist 120 can be performed by a controller 130 connected via a cable 131. The controller 130 is equipped with a display 137.

A hoist camera 124 is attached to the hoist 120. The hoist camera 124 is capable of capturing moving images and is fixed facing downward so as to capture images vertically below. The hoist camera 124 may be a still camera that captures still images. A display device 123 is attached to the hoist 120 and faces downward. In this embodiment, a liquid crystal display is used as the display device 123, but other displays such as organic EL, LED, and the like can also be used. The display device 123 displays to the operator or the like information useful during operation of the crane, such as the direction of movement of the hoist 120.

The mechanism by which the hoist 120 moves will be described below. In a facility where the overhead crane 100 is installed, traveling rails 101, 102 are laid parallel and horizontally near the ceiling of the building. Saddles 111, 112 are put onto the traveling rails 101, 102, enabling movement along the traveling rails as indicated by arrow a, driven by a motor. The crane girder 110 is mounted across saddles 111 and 112, spanning both. The crane girder 110 is installed horizontally and perpendicular to the traveling rails 101, 102. When the saddles 111, 112 move in the direction of the arrow a, the crane girder 110 can also move as a single unit. The hoist 120 is mounted on the crane girder 110 and can be motor-driven along it in the direction of arrow b.

Therefore, by combining the movement of the crane girder 110 in the direction of arrow a and the movement of the hoist 120 in the direction of arrow b, the hoist 120 can move arbitrarily in the space between the traveling rails 101, 102.

In this embodiment, a mechanism for detecting the position of the hoist 120 is provided. As shown in the figure, a marker 103 for detecting the position is drawn on the traveling rail 102. By optically reading the marker 103 with a sensor 113 fixed to the saddle 112, the amount of movement of the saddle 112, and therefore the position of the saddle 112 in the direction a, can be detected. Similarly, a marker 114 for position detection is drawn on the crane girder 110. When the hoist 120 moves, the marker 114 is optically read by a sensor 127 fixed to the hoist 120, thereby detecting the amount of movement of the hoist 120 and, in turn, the position of the hoist 120 in the direction b. As a result, it is possible to detect the horizontal position coordinates (x, y) of the hoist 120 based on the results read by the sensors 113, 127.

In this embodiment, a direction board 150 indicating the directions of north, south, east, and west is attached to a wall inside the facility. The direction board 150 is a thin plate with directions drawn on its surface. The direction board 150 may be formed by drawing the direction directly on the wall. The direction board 150 may be fitted with a beacon 151 that emits a predetermined signal indicating the direction. In the example shown in the figure, only north is shown, but the same applies to other directions.

The winding up and winding down of the wire 121 in the hoist 120, the movement of the hoist 120, etc. are controlled by a system control device 140. The system control device 140 is configured as a computer internally equipped with a CPU and memory, and in this embodiment, the functions shown at the bottom of the figure are configured as software. Some or all of these functions may be implemented as hardware.

The sending/receiving unit 141 performs transmission and reception between the controller 130. The sending/receiving unit 141 may receive a signal from a beacon 151. It may also communicate with smartphones or other mobile terminals held by people within the facility.

The crane position detection unit 145 detects the position coordinates (x, y) of the hoist 120. The display direction determination unit 147 detects the direction in which the display 137 attached to the controller 130 is facing.

The mode switching unit 142 switches the operation mode of the overhead crane 100. In this embodiment, the operating modes include an immediate movement mode in which the hoist 120 immediately starts moving when the direction of movement is specified with the controller 130, and a preview display mode in which the direction of movement is previewed on the display device 123 when the direction of movement is specified, and then the hoist 120 starts moving. More operation modes may be set, or the device may operate in only one mode. If the operation mode is not switched, the mode switching unit 142 may be omitted.

The display control unit 146 controls the display content of the display 137. The terminal detection unit 148 detects smartphones and other mobile terminals in the facility. The crane movement control unit 143 controls the movement of the hoist 120 in accordance with instructions from the controller 130. The display device control unit 144 controls the display content of the display device 123 attached to the hoist 120.

Some of the above-mentioned functions may be omitted, or more functions may be added. Furthermore, the system control device 140 does not necessarily have to be attached to the hoist 120, and may be provided as a device separate from the hoist 120. For example, the system control device 140 may be installed in a facility where the overhead crane 100 is installed, and the operation thereof may be controlled by communication with the hoist 120 or the like. Furthermore, some of the functions of the system control device 140 may be provided by a server connected to a network such as the Internet.

In this embodiment, the hoist 120, the crane girder 110, the saddles 111, 112, and the traveling rails 101, 102 correspond to the crane device in the claims. Moreover, the overhead crane 100 corresponds to a crane system in the claims.

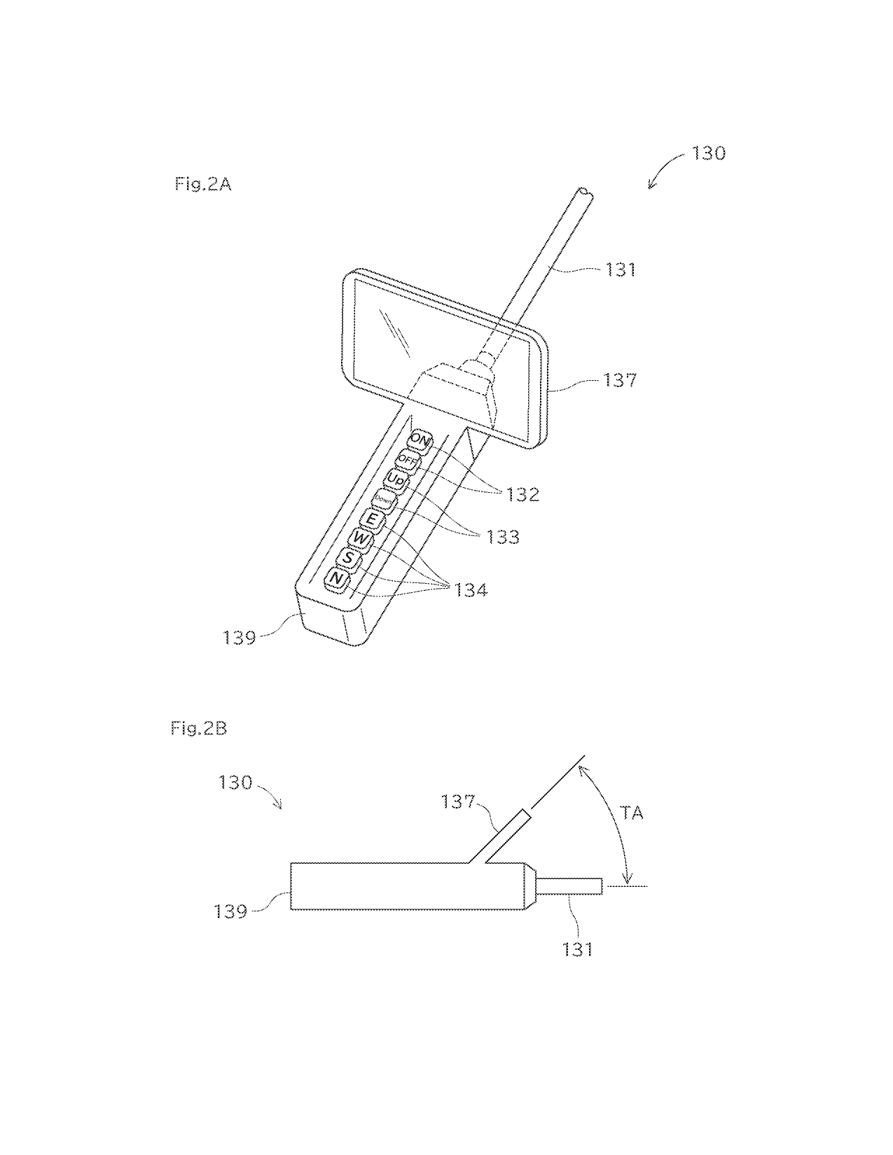

FIGS. 2A and 2B are explanatory diagrams showing the configuration of the controller 130. FIG. 2A shows a perspective view, and FIG. 2B shows a side view. The controller 130 has a main body 139 that is held by the operator and operated by hand, and is provided with push buttons 132 for turning the power on and off, push buttons 133 for winding up or winding down the wire 121, and four push buttons 134 for moving in the four directions of north, south, east, and west.

The controller 130 is equipped with a display 137 that displays various characters and images. As shown in FIG. 2A, the display 137 is attached above the push buttons 132, 133, and 134. The upper side is defined as the state in which the controller 130 is held in the hand for operation. It may also be defined as the upward direction of the characters written on these push buttons 132, 133, and 134, or the side from which cable 131 protrudes. By attaching the display 137 above the push buttons 132, 133, and 134, there is an advantage that the push buttons 132, 133, and 134 can be operated without being blocked by the display 137.

As shown in FIG. 2B, the display 137 is attached to the top surface of the controller 130, that is, the surface on which the push buttons 132, 133, and 134 are provided, at a tilt angle TA. The tilt angle TA can be determined arbitrarily, but it is preferable to set it at an angle such that the surface of the display 137 is nearly vertical when the controller 130 is held in the hand and operated. By doing so, if a camera is installed to the back of the display 137, the camera can capture images inside of the facility while the controller 130 is being operated. The tilt angle TA may be adjustable.

In this embodiment, the display 137 is a built-in type that is fixed to the controller 130. The display 137 may be configured to be detachable from the controller 130. A mobile terminal such as a smartphone may be used as the display 137.

In the embodiment, the controller 130 is not limited to the configuration shown in FIG. 2. For example, instead of the four push buttons 134, the direction of movement of the hoist 120 may be instructed by rotating the controller itself around the central axis of a cylindrical housing. The controller 130 may be a wireless controller instead of a wired controller connected via a cable 131.

The crane system is not limited to the configuration described above, and can have various other configurations.

### B. Display Use Examples:

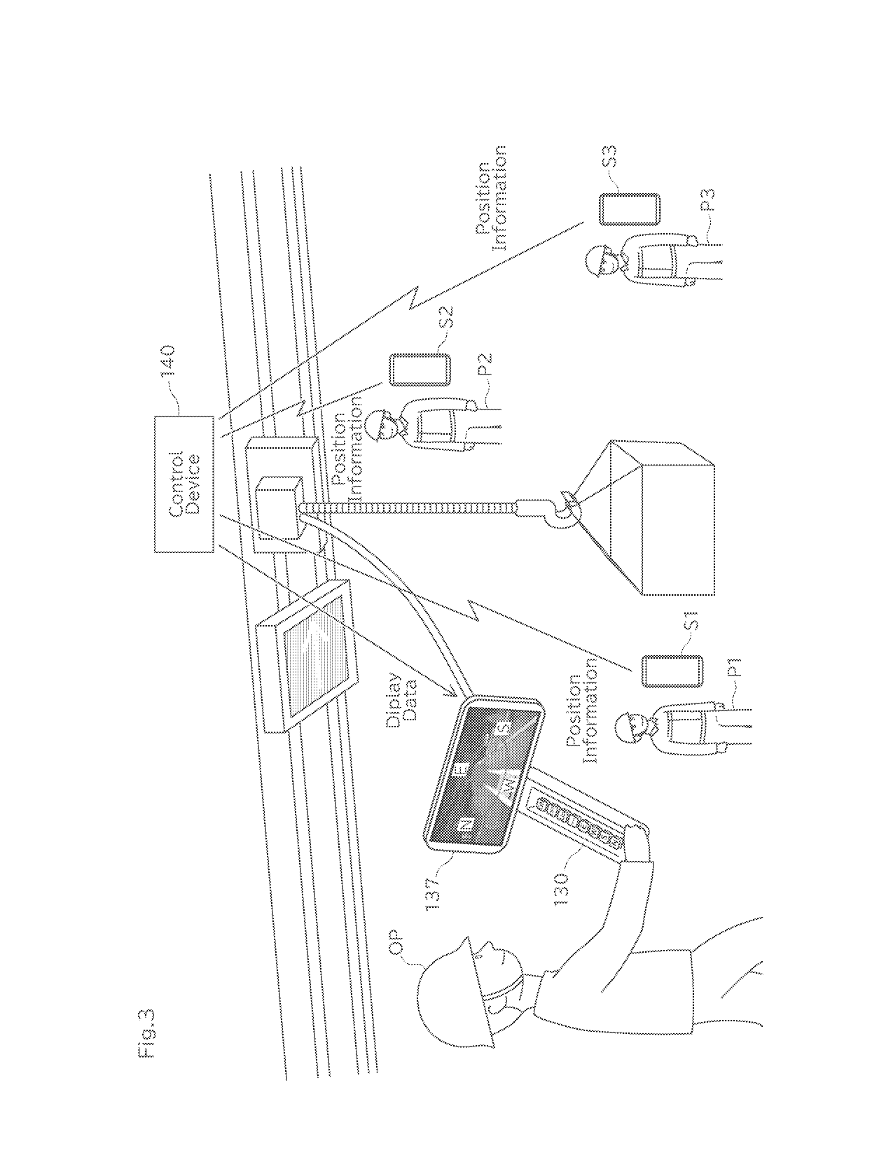

FIG. 3 is an explanatory diagram showing the overview of a display during operation. An example is shown in which an operator OP operates a crane using the controller 130 in a facility. In addition to the operator OP, there are workers P1, P2, and P3 in the facility. Each of the workers P1 to P3 has a smartphone as a mobile terminal S1 to S3.

During operation, the system control device 140 of the crane system acquires the position information of the mobile terminals S1 to S3 of the workers P1 to P3. The position information can be obtained, for example, by using the GPS function of the mobile terminals S1 to S3. The system control device 140 then displays information on the display 137 of the controller 130 to assist in the operation of the crane. The display may include, for example, an arrow indicating the direction of movement of the crane and the positions of the workers P1 to P3. If the direction of movement is displayed, the operator OP can easily notice the error if he or she has operated the crane incorrectly. If the positions of the workers P1 to P3 are displayed, it is possible to reduce exposure to these operators. By displaying these indications, the safety of the crane system can be improved. The display 137 is attached to the controller 130, which has the advantage that the operator OP can easily check the display during operation.

FIG. 3 shows one example of how the display 137 is used, and the display 137 can also display various other items, as will be described later.

The display contents and the processes for realizing them in the overhead crane 100 of the embodiment will be described below.

### C. Display Direction Determination Process:

To help the operator understand the displayed content intuitively, the content should be shown in alignment with the direction in which display 137, attached to controller 130, is oriented. As an example, consider the case where the operator is facing north and issues an instruction to move east. The display 137 attached to the controller 130 should also be facing north, just like the operator, so if the word "East" is displayed on the right side of the display 137 or an arrow pointing to the right is displayed, it will be easier to intuitively recognize movement toward the east. To realize such processing, it is necessary to detect the direction of the display 137 in the horizontal plane. Here, the direction of the display 137 can be defined as the direction indicated in the horizontal plane by a vector obtained by rotating the normal vector of the display 137 by 180 degrees.

The direction of the display 137 does not necessarily correspond to the exact geographical direction (orientation). This is because the direction of the facility in which the overhead crane 100 is installed does not necessarily match the geographical direction (or geographic orientation). For example, the "North" side direction board 150 shown in FIG. 1 is attached to a wall that is generally in the north direction, but does not necessarily point exactly toward geographic north (i.e., oriented to the north). For the purpose of providing a display that is easy for the operator to understand intuitively, the direction of the display 137 may be a local direction defined in the facility where the overhead crane 100 is installed. Local direction can be defined as "North" in the direction of one wall of the facility.

Three methods for identifying such a direction will be described below. Either method may be selected and used, or they may be used in combination, or they may be used by switching between them.

### C1. Method 1:

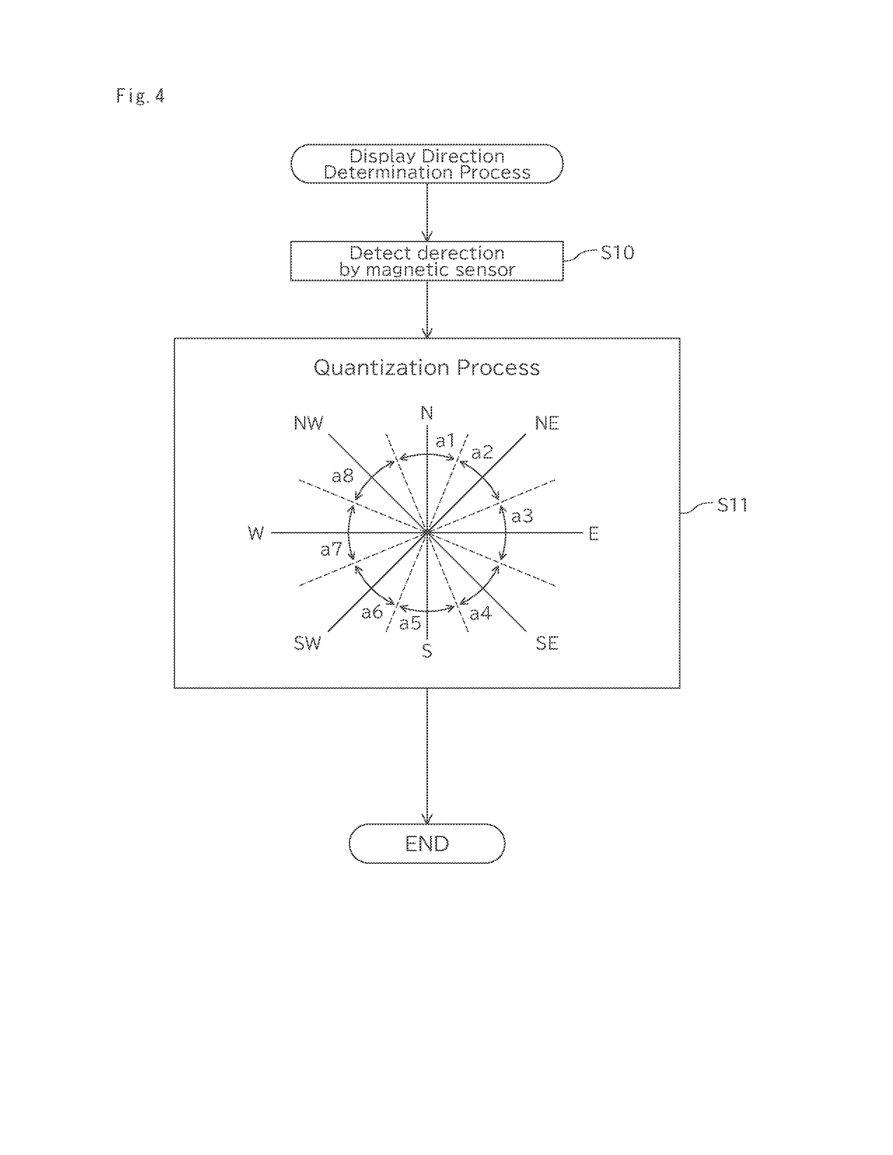

FIG. 4 is a flowchart of the display direction determination process (1). This is a processing executed by the display direction determination unit 147 (see FIG. 1), and in terms of hardware, it is a processing executed by the CPU of the system control device 140. This function may be implemented by the controller 130 or the display 137.

When the process starts, the CPU detects the direction using the magnetic sensor (Step S10). The magnetic sensor is a device also known as a geomagnetic sensor or an electronic compass. In this embodiment, the magnetic sensor may be attached to the display 137 or the controller 130. When a smartphone or the like is used as the display 137, a magnetic sensor in the smartphone may be used. The magnetic sensor does not have to be integral with the display 137 or controller 130, but may be held by the operator.

Next, the CPU performs a quantization process (Step S11). The quantization process is allocating the direction detected by the magnetic sensor to a predetermined direction that has been set in advance. An image of the quantization process is shown in the figure. As shown in the figure, if the detected direction falls within range a1 centered on north (N), "North (N)" is assigned. Similarly, range a2 is assigned northeast (NE), range a3 is assigned east (E), range a4 is assigned southeast (SE), range a5 is assigned south (S), range a6 is assigned southwest (SW), range a7 is assigned west (W), and range a8 is assigned northwest (NW).

By doing so, the direction can be easily assigned. In the figure, eight directions are set, but four directions, or more than eight directions may be set.

The direction does not have to match the geographic direction. It may be set based on the local direction within the facility where the overhead crane 100 is installed. As a result, for example, it is acceptable for the north (N) direction to deviate from geographic north. The ranges a1 to a8 for allocating the directions do not need to be uniform. For example, it is possible to set the ranges of north, south, east, and west broadly and the ranges of the other four directions narrowly.

### C2. Method 2:

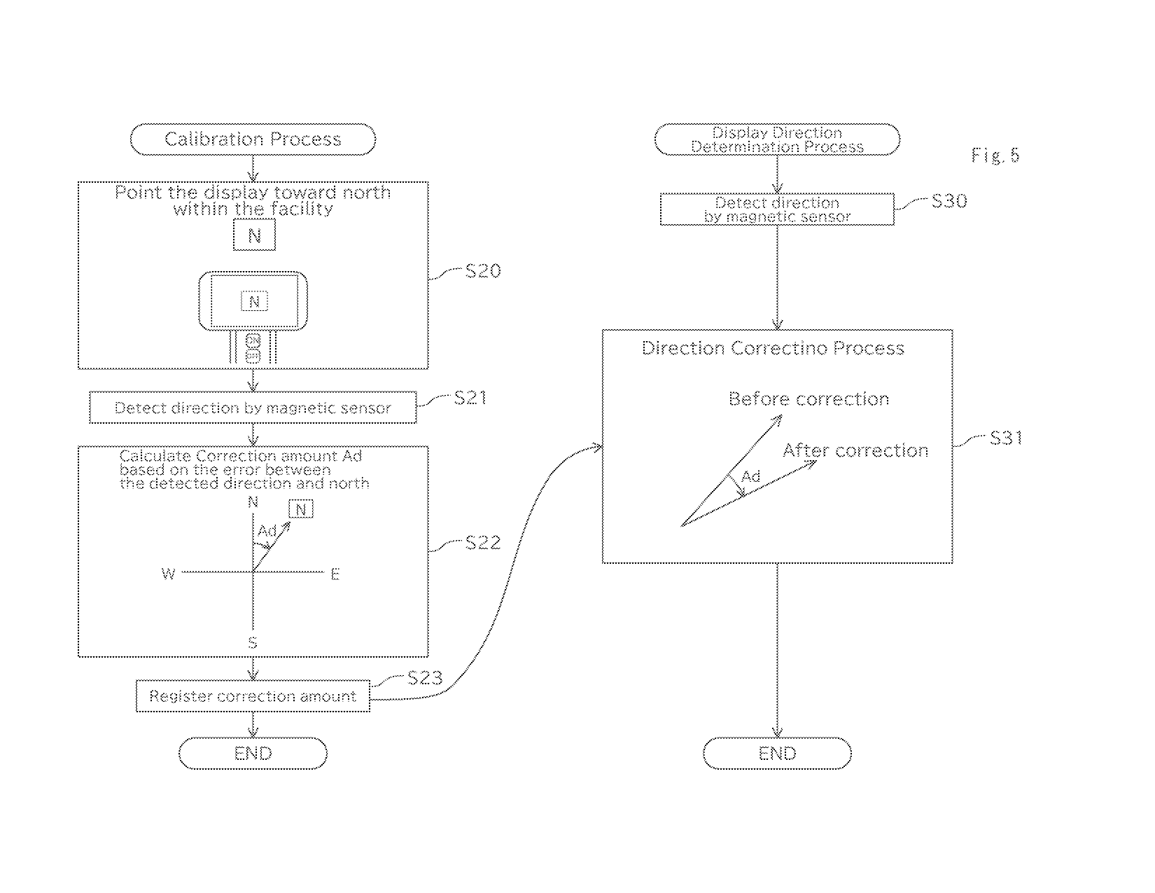

FIG. 5 is a flowchart of the display direction determination process (2). This is a processing executed by the display direction determination unit 147 (see FIG. 1), and in terms of hardware, it is a processing executed by the CPU of the system control device 140. This function may be implemented by the controller 130 or the display 137.

This method involves a process of calculating the direction of the display 137 by correcting the direction detected by the magnetic sensor. The left side of the figure shows the calibration process that is performed in advance. This is a process for determining the correction amount Ad for carrying out the above correction.

First, the operator points the display 137 toward the north direction in the facility (Step S20), and the CPU detects this. For example, the operator may operate the controller 130 or the display 137 to input that the vehicle is facing north, or the detection value of the magnetic sensor may be detected by remaining almost unchanged for a predetermined period of time. Next, the CPU detects the direction of the magnetic sensor in this state (Step S21).

Then, a correction amount Ad is calculated based on the error between the detected direction and north (step S22). The method for calculating the correction amount Ad is shown in the figure. When the "North" in the local direction within the facility deviates from the geographical north, south, east and west (N, S, E, W), the direction detected in Step S21 will be deviated from geographical north (N) as shown in the vector in the figure. The difference between this vector and geographic north (N) is the correction amount Ad. The calculated correction amount Ad is registered in the display direction determination unit 147 for use in subsequent processing (Step S23).

After the calibration process is completed, the display direction determination process shown on the right side of the figure is performed while the crane is being operated. In this process, the CPU detects the direction using the magnetic sensor (Step 30). Then, the direction correction process is performed using the correction amount Ad obtained in the calibration process (Step S31). As shown in the figure, the corrected direction is obtained by adding a correction amount Ad to the detected pre-correction direction.

By doing so, the direction of the display 137 can be determined by a relatively simple calculation in accordance with the local direction within the facility. In the display direction determination process (2), since direction quantization is not performed, there is an advantage that the direction can be identified with the same resolution as the detection sensor.

### C3. Method 3:

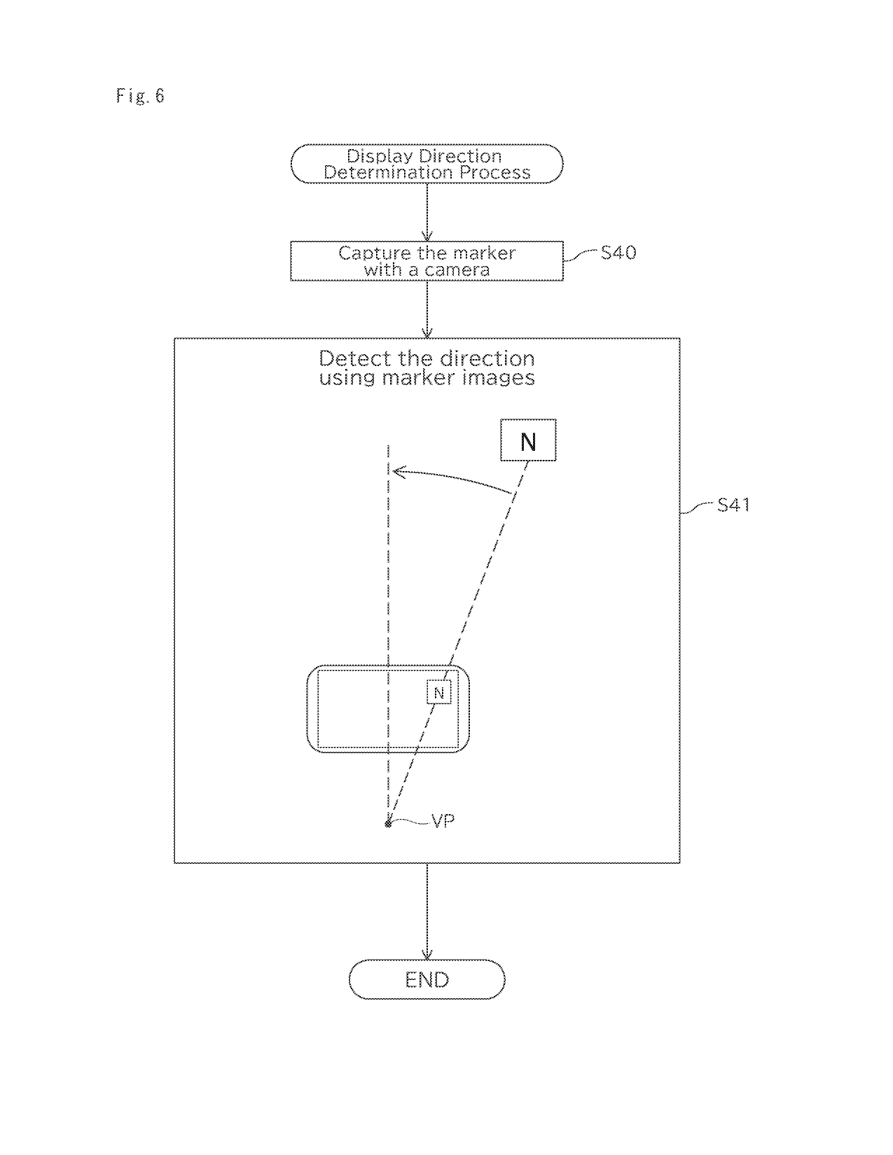

FIG. 6 is a flowchart of the display direction determination process (3). This is executed by the display direction determination unit 147 (see FIG. 1), and in terms of hardware, it is executed by the CPU of the system control device 140. This function may be implemented by the controller 130 or the display 137. In this process, the direction is determined using markers installed within the facility, without using a magnetic sensor.

When the process starts, the CPU captures the marker with the camera (Step S40). It is desirable that the direction of the camera be substantially the same as that of the display 137, so for example, a camera installed on the back of the display 137 can be used. A camera may be installed on the controller. The marker to be captured may be a direction board 150 installed within the facility.

Next, the CPU determines the direction based on the marker image (Step S41). An image of the determination method is shown in the figure. If the viewpoint position and angle of view at the time of capturing by the camera are known, the direction of the camera, and therefore the direction of the display 137, can be determined by analyzing based on the positions of the markers in the image as shown in the figure.

This method has the advantage that the direction can be determined without using a magnetic sensor. In addition to the direction board 150, the marker may be a line drawn on the floor of the facility to indicate the direction, or equipment within the facility may be used as the marker.

The direction of the display 137 is not limited to the above process. For example, signals may be received from beacons 151 installed in each direction within the facility, and the direction may be identified based on the strength of the signals. The direction of the display 137 obtained by the above processes can be used for the following displaying on the display 137.

### D. Display Process:

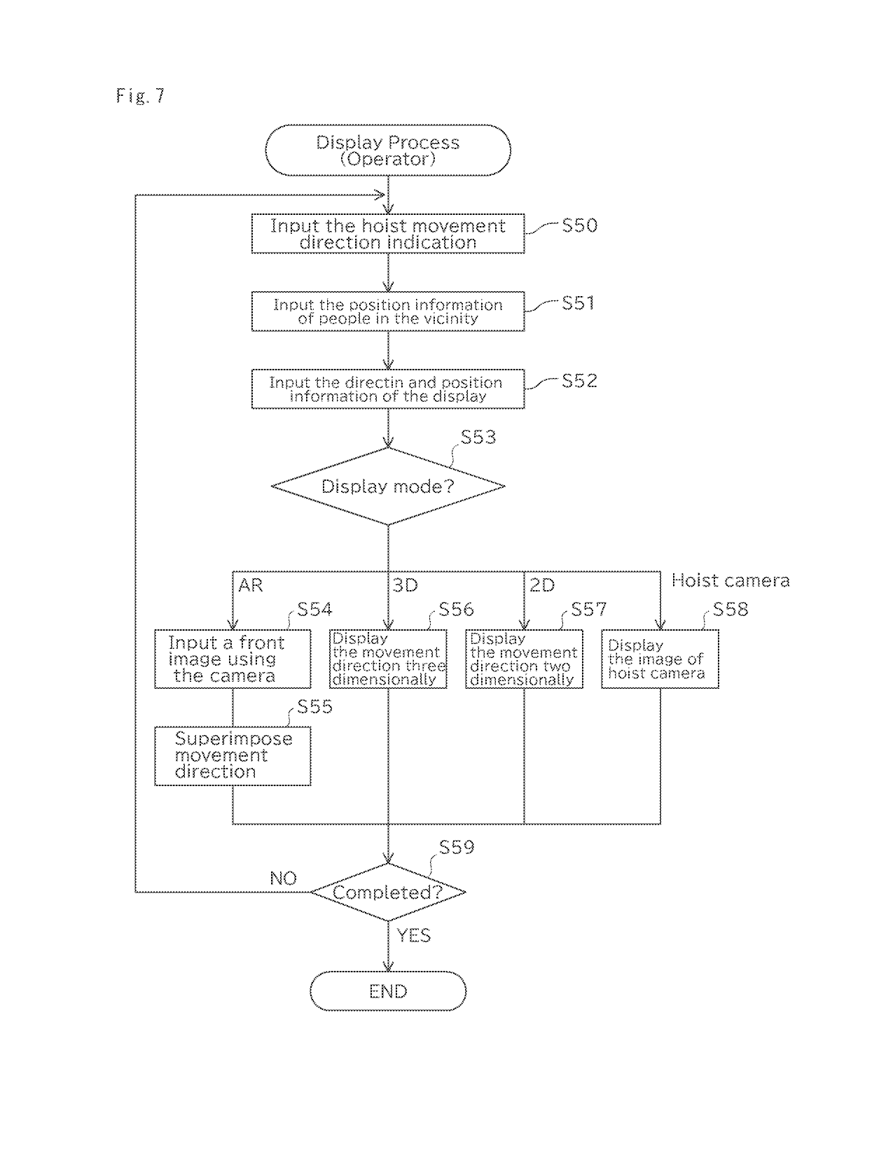

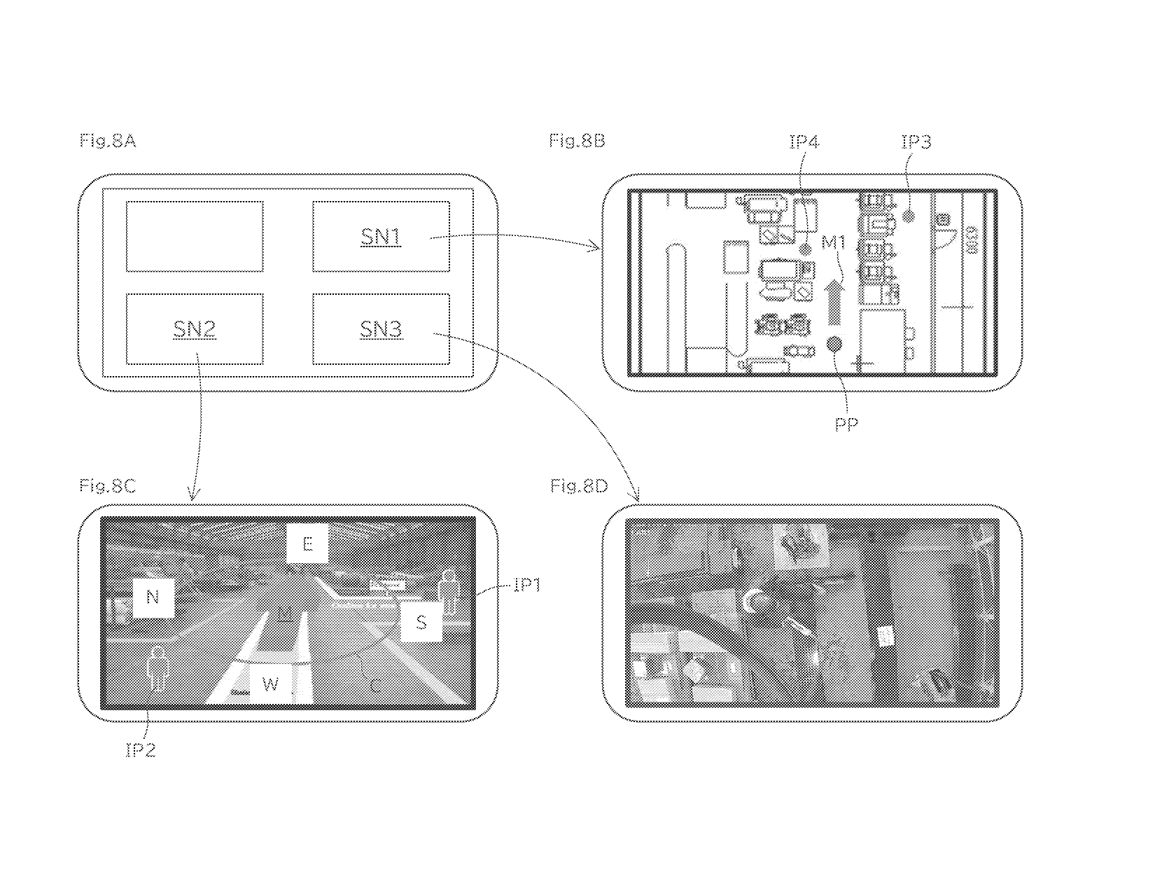

FIG. 7 is a flowchart of the display process (operator). FIG. 8 is an explanatory diagram showing an example of a display screen of a display. The contents of the display process will be described with reference to these figures. The display process is a process for displaying information on the operator's display 137, which is, the display 137 attached to the controller 130. This is a process performed by the display control unit 146 (see FIG. 1), and in terms of hardware, it is a process executed by the CPU of the system control device 140. The display control unit 146 may be provided in the controller 130 or the display 137.

Specifically, The system control device 140 can generate image data for display and send it directly to the display 137. Alternatively, information required to display an image or the like may be transmitted from the system control device 140 to a display control unit 146 provided in the display 137, and image data may be generated and displayed on the display 137 side. Furthermore, a display control unit 146 provided in the display 137 may acquire necessary information and display it.

When the process starts, the CPU inputs an instruction regarding the direction of movement of the hoist 120, that is, the operation details of the controller 130 (Step S50). The CPU also inputs the position information of the people in the vicinity (Step S51). The people in the vicinity refer to people who are not involved in the operation of the crane but are present around the crane, such as the workers P1 to P3 shown in FIG. 3. The position information of these people can be obtained, for example, from the smartphones carried by each person. Instead of a smartphone, each person may carry a device for detecting position information. Additionally, the presence and position of a person may be identified by analyzing images captured by a hoist camera 124 attached to the hoist 120.

Next, the CPU inputs the direction and position information of the display 137 (Step S52). The direction of the display 137 can be obtained by the method described above with reference to FIGS. 4 to 6. The position of the display 137 may be determined by a GPS provided

on the controller 130 or the display 137. The identification may be made by analyzing images captured by a hoist camera 124 attached to the hoist 120.

Next, the CPU executes a display process according to the display mode of the display 137 (Step S53). FIG. 8A shows an example of a screen for selecting a display mode. As shown in the figure, thumbnails SN1 to SN3 of screens in various modes are displayed, and by selecting one of them, the display mode can be selected. In FIG. 8A, when thumbnail SN3 is selected, the hoist camera mode is set and the display shown in FIG. 8D is displayed.

If the hoist camera mode is selected, the CPU displays an image captured by the hoist camera 124 on the display 137 (Step S58 in FIG. 7). The hoist camera 124 captures an image looking down from the hoist 120, so this display makes it possible to check the condition of the load and the position of people around it, as shown in FIG. 8D. The image captured by the hoist camera 124 may be displayed as is, or may be displayed as a heading display, i.e., rotated to match the direction of the display 137, to make it easier to understand intuitively.

In FIG. 8A, when thumbnail SN1 is selected, the 2D mode is set and the display shown in FIG. 8B is displayed. If the 2D mode is selected, the CPU displays the movement direction two-dimensionally (Step S57 in FIG. 7). As shown in FIG. 8B, a two-dimensional map of the facility is displayed, on which the operator's position PP, the positions IP3 and IP4 of people around the operator, and the instructed direction of movement M1 are displayed. The position of the hoist 120 may be displayed. These displays allow the operator to check the surrounding situation and the direction of movement of the hoist 120. This two-dimensional map may also be displayed with the top of the display 137 fixed to a specific direction such as north, or may be rotated to match the direction of the display 137.

A sound may be output along with the display of the direction of movement. For example, the direction of movement may be read out aloud, or a sound may be output to notify the start or stop of movement. This can improve safety.

In FIG. 8A, when thumbnail SN2 is selected, the 3D mode is set and the display shown in FIG. 8C is displayed. If the 3D mode is selected, the CPU displays the direction of movement of the hoist 120 in three dimensions (Step S56 in FIG. 7). As shown in FIG. 8C, the state of the facility is displayed on a three-dimensional map, and the positions IP1 and IP2 of people in the vicinity are displayed on the map, along with the instructed direction of movement M. This allows the operator to check the surrounding situation and the direction of movement. This three-dimensional map may also be displayed with the top of the display 137 fixed to a specific direction such as north, or may be rotated to match the direction of the display 137. The circle C in FIG. 8C is displayed to make it easier to recognize the direction. It is also possible to omit it.

In FIG. 8A, when the thumbnail SN2 is selected, the AR mode may be selected instead of the 3D mode. The display in AR mode is the same as that shown in FIG. 8C. If the AR mode is selected, the CPU inputs an image of the front using the camera (Step S54 in FIG. 7). Preferably, a camera mounted on the back of the display 137 is used. The camera may be installed to the controller 130 or may be separate from the controller 130. The front image is an image captured in the operator's line of sight, that is, in the direction behind the display 137.

The CPU superimposes the direction of movement on the front image and displays it on the display (Step S55). As shown in FIG. 8C, the instructed direction of movement M is displayed overlaid with a captured image of the facility. The positions IP1 and IP2 of the people in the vicinity may also be displayed. In addition, a circle C representing a direction or a horizontal plane may also be displayed. These displays allow the operator to check the surrounding situation and the direction of movement.

The CPU repeatedly executes the above processes until the process is completed (Step S59). It should be noted that various modifications are possible in the above processing. For example, the direction of movement of the hoist 120 may be displayed according to an instruction from the controller 130 before the start of movement, and the actual direction of movement may be displayed during movement. The direction of movement may be displayed before the movement starts or after the movement starts. Display of surrounding people may be omitted.

In this embodiment, the display is also provided on a display held by a person other than the operator. The displays for users other than the operator can be, for example, smartphones carried by the users themselves. Also, a display device dedicated to this embodiment may be provided.

When using their own smartphones, they must register them in advance with the system control device 140 and install a display application. The display may be performed by each person logging in to the application. Additionally, it may be possible to automatically display information when a registered smartphone is detected within the facility using its position data. Furthermore, communication between the system control device 140 and the smartphone may be performed using short-range communication such as Bluetooth (registered trademark), and the display may be made when the smartphone comes within a predetermined distance range from the system control device 140.

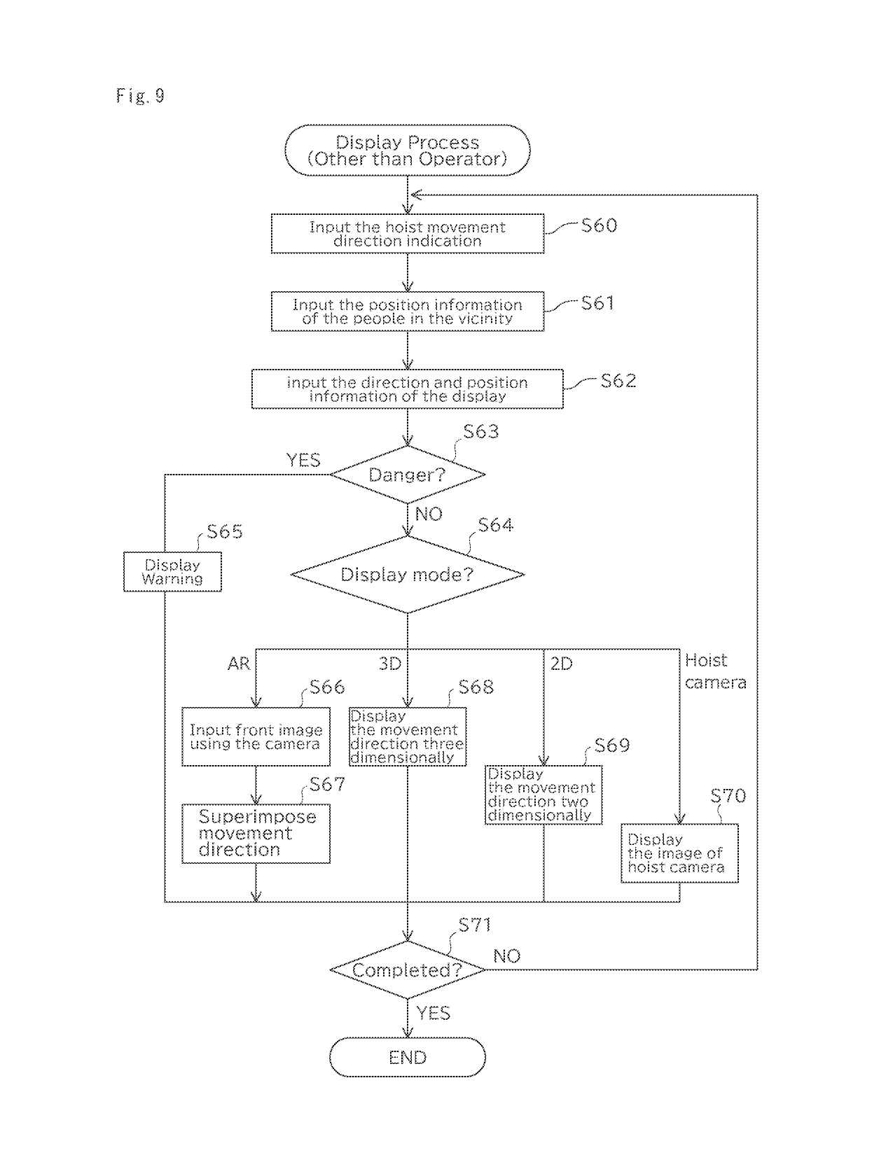

FIG. 9 is a flowchart of the display process (other than the operator). This processing is performed by the display control unit 146 (see FIG. 1), and in terms of hardware, is executed by the CPU of the system control device 140. The display control unit 146 may be realized by an application installed on each person's smartphone.

When the processing starts, the CPU inputs instructions regarding the direction of movement of the hoist, the position information of people in the vicinity, and the direction and position information of the displays held by the people in the vicinity, similar to the display processing described in FIG. 7 (Steps S60, S61, S62). Furthermore, the position and orientation of the display 137 attached to the controller 130 may be input.

Next, the CPU determines whether or not there is danger (Step S63). For example, if a person is within a predetermined distance around the hoist 120, it may be determined that there is a danger. It may be determined that there is a danger if there is a person in the direction of movement of the hoist 120. Danger can be determined based on various other conditions.

If it is determined that there is danger, the CPU displays an alarm to notify the user of the danger (Step S65). Sound may be output in conjunction with the display. This alarm display may be directed only at smartphones held by individuals deemed to be in danger, or it may be directed at all displays and smartphones within the facility, including those of the operator.

If it is determined that there is no danger, a display is made according to the display mode (Step S64), as explained in FIG. 7. In the hoist mode, an image from the hoist camera is displayed (Step S70). In the 2D mode, the direction of movement of the hoist 120 is displayed two-dimensionally (Step S69). In the 3D mode, the direction of movement of the hoist 120 is displayed in three-dimensionally (Step S68). These indications may be aligned with the direction of the display. In this case, the display may be adjusted to match the display held by each person, or may be adjusted to match the display of the operator.

In the AR mode, a front image is input by the camera (Step S66), and the moving direction is superimposed and displayed (Step S67). The images in AR mode may be images captured by the camera of a smartphone held by each person, or may be images taken by a camera attached to the controller 130.

The CPU repeatedly executes the above processes until the process is completed (Step S71). In the process described with reference to FIG. 9, various modifications are possible, similar to those explained in FIG. 7.

### E. Second Embodiment:

Next, a crane system according to a second embodiment will be described. In the first embodiment, an example in which the display is integrated with the controller is shown. In the second embodiment, an example in which the display is detachable is shown. In this case, a mobile terminal such as a smartphone can be used as a display.

### E 1. Controller Configuration:

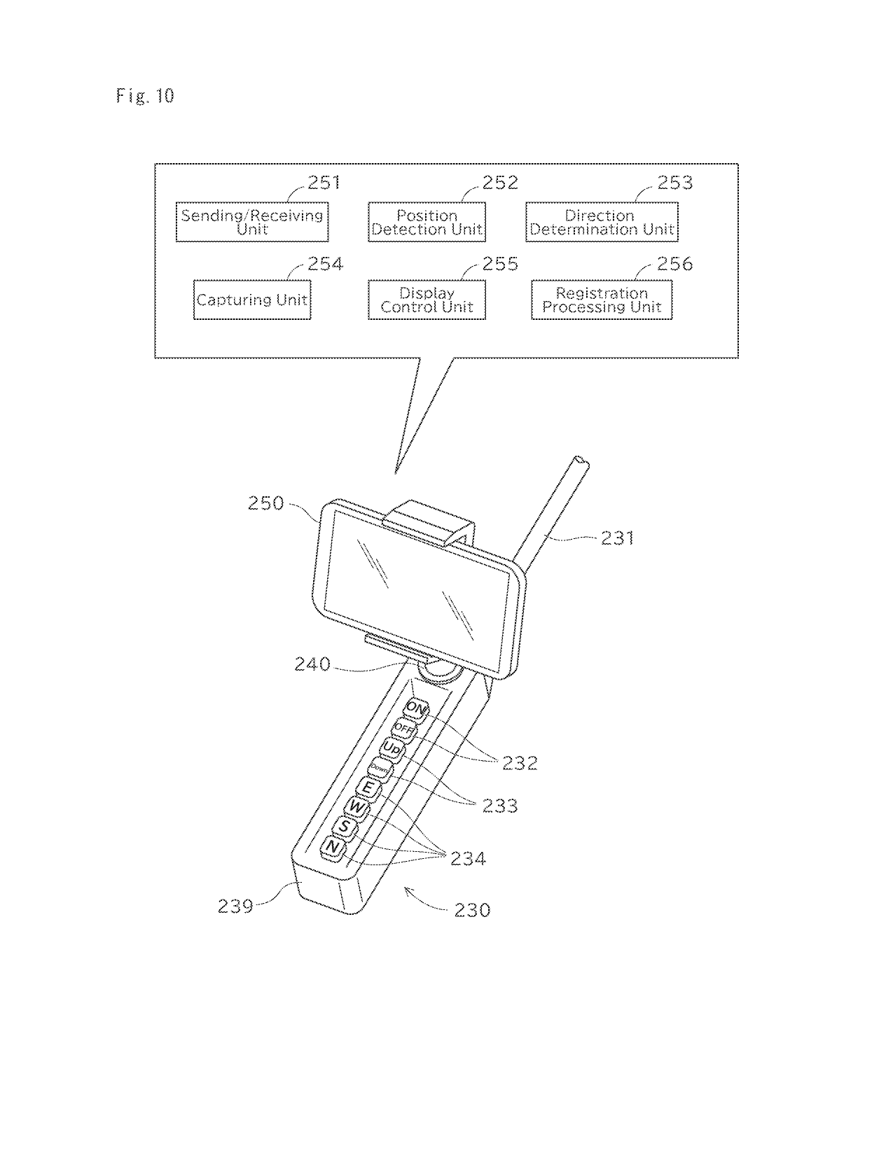

FIG. 10 is an explanatory diagram showing the configuration of the controller 230 in the second embodiment. The controller 230 has a main body 239 that is held by the operator and operated by hand, and is provided with push buttons 232 for turning the power on and off, push buttons 233 for winding up or winding down the wire, and four push buttons 234 for moving in the four directions of north, south, east, and west.

A mobile terminal 250 such as a smartphone is detachably attached to the controller 230 via an attachment 240. In the second embodiment, the mobile terminal 250 functions as a display. As in the first embodiment, the mobile terminal 250 is attached above the push buttons 232, 233, and 234, that is, on the side where the cable 231 protrudes. As in the first embodiment, the mobile terminal 250 is attached at an angle to the top surface of the controller 230.

The attachment 240 may be fixed to the controller 230 or may be detachably attached thereto. It is preferable that attachment 240 has a mechanism that can hold the camera provided on the rear surface of the mobile terminal 250 without interfering with the camera.

By installing predetermined applications on the mobile terminal 250, each of the functions shown in the figure are configured via a software. The sending/receiving unit 251 transmits and receives various information to and from the system control device 140 that is a part of the crane system. The position detection unit 252 detects the position information of the mobile terminal 250 using a GPS or the like. The direction determination unit 253 detects the direction of the portable terminal 250 using a magnetic sensor or the like in the mobile terminal 250, using the method described in FIGS. 4 to 6 of the first embodiment. The capturing unit 254 captures images using a camera provided in the mobile terminal 250. The display control unit 255 displays various information on the display of the mobile terminal 250. The registration processing unit 256 registers the mobile terminal 250 in the system control device 140 of the overhead crane 100.

Some of these functions may be provided by the operating system (OS) of the mobile terminal 250. In the second embodiment, some of the functions configured in the system control device 140 may be omitted depending on the functions realized by the mobile terminal 250. Furthermore, the system control device 140 may be provided with additional functions required for using the mobile terminal 250.

### E 2. Display Registration Process:

In the first embodiment, the display is built into the controller, but in the second embodiment, the mobile terminal 250 is used as the display. Since any mobile terminal 250 can be used, in the second embodiment, a process is required to register which mobile terminal 250 is attached to the controller 230. This registration can be performed, for example, in one of three methods as described below. Any one of these methods may be used, or an operator or the like may be allowed to select any one of the methods.

### E 2-1. Method 1:

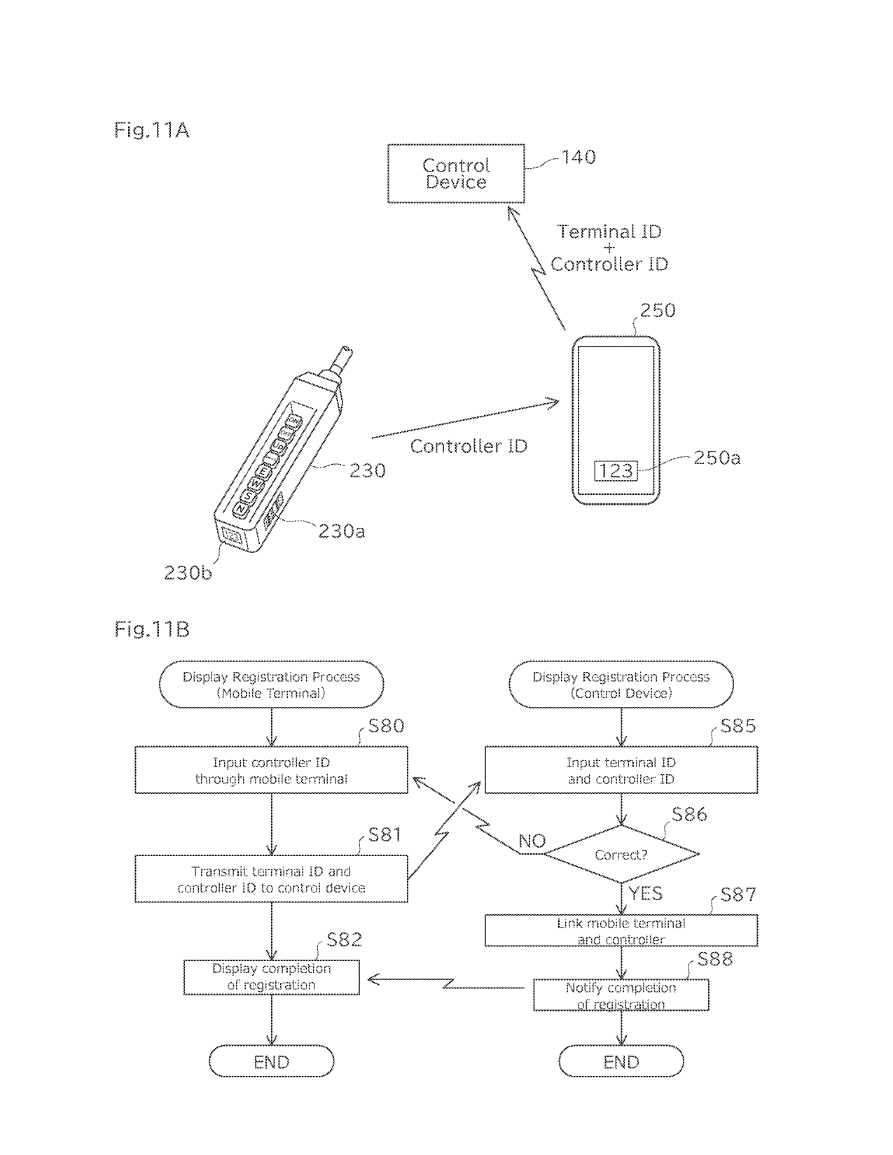

FIG. 11A is an explanatory diagram of the display registration process (1). FIG. 11A shows an outline of the registration method. The controller 230 is assigned unique identification information, that is, a controller ID. As shown in the figure, the controller ID is a barcode 230a or a visible code 230b such as a number, attached to the surface. The mobile terminal 250 inputs the controller ID and transmits it to the system control device 140 together with its own identification information, that is, the terminal ID. In this way, the controller 230 and the mobile terminal 250, what is the display, can be linked.

The terminal ID may be identification information that can identify the hardware, or may be a user ID used when using an application installed on the mobile terminal 250. The controller ID may be input by, for example, reading the barcode 230a with the camera of the mobile terminal 250. The code 230b may also be entered using the touch panel 250a of the smartphone. Alternatively, the controller 230 may be provided with an IC chip or the like that stores the controller ID, which can be read by the mobile terminal 250.

If only one controller 230 is used within the facility, the controller ID may be omitted as it is known. The mobile terminal 250 may transmit a terminal ID to the system control device 140 to indicate that it is attached to the controller.

FIG. 11B is a flowchart showing the process for realizing the above-described registration method. The left side shows the processing executed by the mobile terminal 250, and the right side shows the processing executed by the system control device 140. As shown in the figure, the mobile terminal 250 inputs the controller ID(Step S80). Then, the controller ID is transmitted to the system control device together with the terminal ID (Step S81). Meanwhile, the system control device inputs the terminal ID and the controller ID transmitted from the mobile terminal 250 (Step S85).

Then, it is determined whether this information is correct (Step S86). If it is determined that either or both of the controller ID and the terminal ID are not correct, for example, because they do not match those registered in advance in the system control device, the user is prompted to input the controller ID again (Step S80). If it is determined that the terminal ID and controller ID are correct (Step S86), they are linked and registered (Step S87), and a notification of registration completion is sent (Step S88). In response to this, the mobile terminal 250 displays a message indicating that registration is complete (Step S82). This allows any mobile terminal 250 to be used in the same way as the display 137 in the first embodiment.

### E 2-2. Method 2:

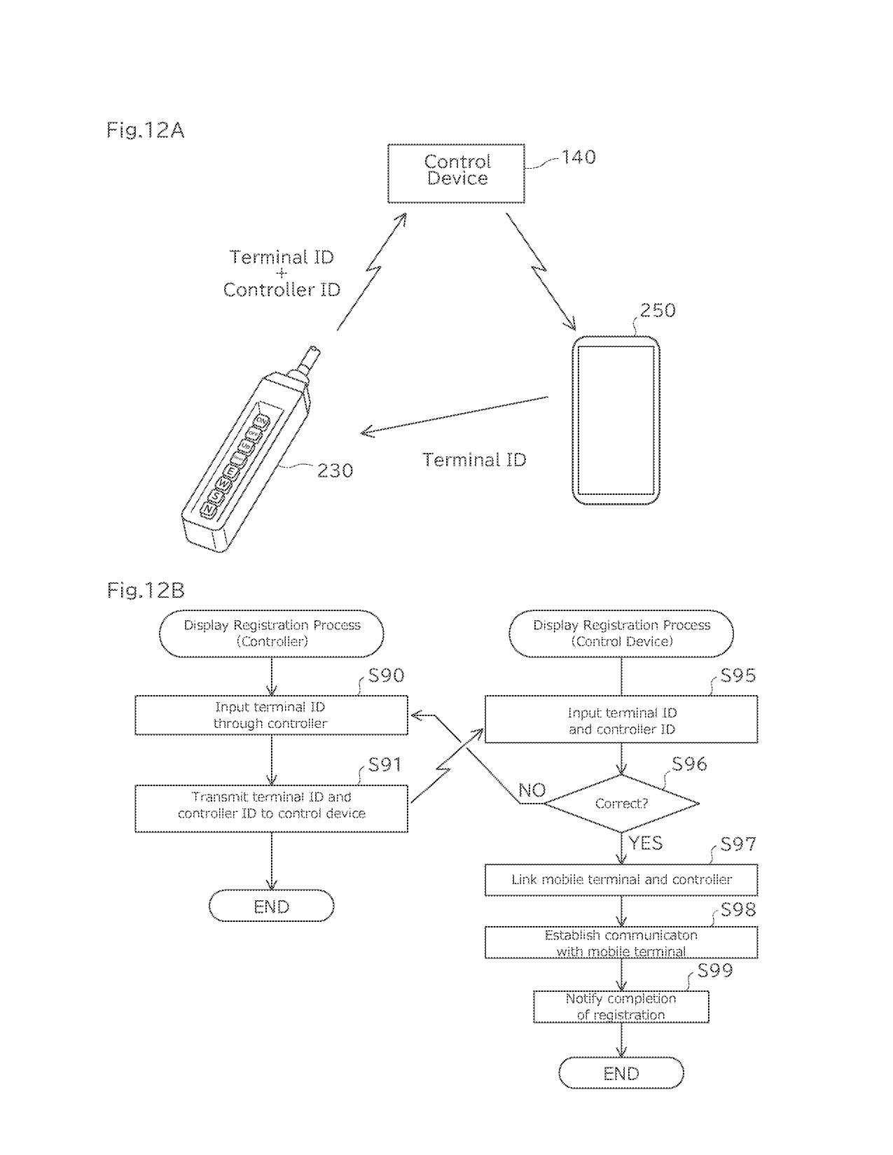

FIG. 12A is an explanatory diagram of the display registration process (2). FIG. 12A shows an outline of the registration method. The controller 230 communicates with the mobile terminal 250 to read the identification information of the mobile terminal 250, that is, the terminal ID. This communication may be performed automatically when the mobile terminal 250 is brought close to the controller 230, or may be instructed by pressing a button on the controller 230 or operating the screen of the mobile terminal 250, or the like. The controller 230 transmits to the system control device 140 a controller ID, which is its own identification information, together with the terminal ID read from the mobile terminal 250.

FIG. 12B is a flowchart showing the process for realizing the above-described registration method. The left side shows the processing executed by the controller 230, and the right side shows the processing executed by the system control device 140. As shown in the figure, the controller 230 inputs the terminal ID(Step S90). Then, the terminal ID and the controller ID are transmitted to the system control device (Step S91). Meanwhile, the system control device inputs the terminal ID and the controller ID transmitted from the controller 230 (Step S95).

If it is determined that this information is not correct (Step S96), the controller ID is requested to be input again (Step S90). If it is determined that the terminal ID and controller ID are correct (Step S96), they are linked and registered (Step S97), communication is established with the mobile terminal 250 (Step S98), and a notification of registration completion is sent (Step S99). This allows any mobile terminal 250 to be used in the same way as the display 137 in the first embodiment.

### E 2-3. Method 3:

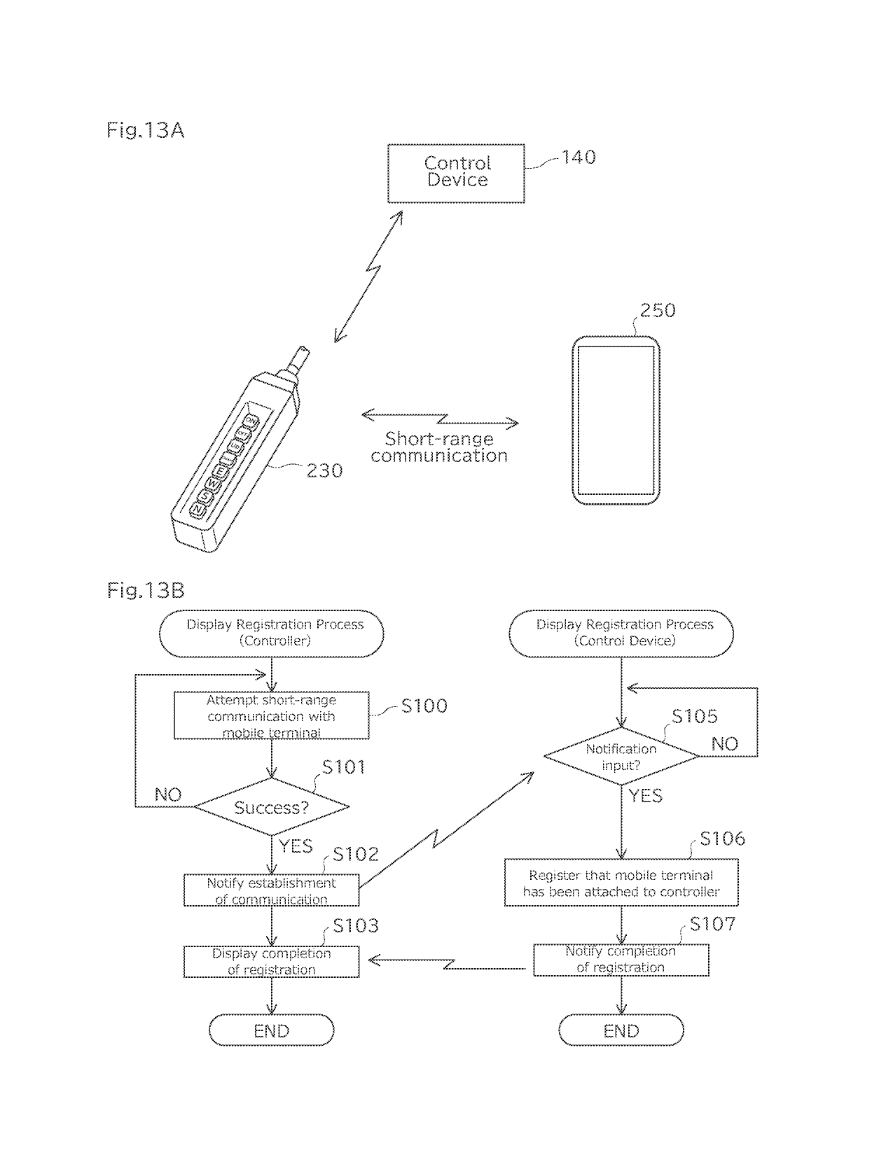

FIG. 13A is an explanatory diagram of the display registration process (3). FIG. 13A shows an outline of the registration method. In this method, the controller 230 establishes short-range communication with the mobile terminal 250 using Bluetooth (registered trademark) or the like, enabling communication of various information. Then, the system control device is notified that communication has been established. In this method, the controller ID and the terminal ID are not associated and registered in the system control device 140. Data to be displayed on the mobile terminal 250 is transmitted to the mobile terminal 250 via the controller 230. In this way, even if the system control device 140 does not know which mobile terminal 250 is attached to the controller 230, it is possible to provide an appropriate display on the mobile terminal 250 attached to the controller 230.

FIG. 13B is a flowchart showing the process for realizing the above-described registration method. The left side shows the processing executed by the controller 230, and the right side shows the processing executed by the system control device 140.

As shown in the figure, the controller 230 attempts to establish short-range communication with the mobile terminal 250 (Step S100). This attempt is repeated until communication is established (step S101). When communication is established, the controller 230 notifies the system control device of this fact (Step S102). Meanwhile, the system control device waits for a notification that communication has been established from the controller 230 (Step S105), and upon receiving the notification, registers that the mobile terminal 250 has been attached to the controller 230 (Step S106). Then, a notification that the registration has been completed is sent to the controller 230 (Step S107). Upon receiving this notification, the controller 230 causes the mobile terminal 250 to display a registration completion screen (Step S103). This allows any mobile terminal 250 to be used in the same way as the display 137 in the first embodiment.

### F. Third Embodiment:

In the first and second embodiments, examples have been shown in which a display capable of displaying various images is used, but the display in the present invention may also be attached to the operation unit of the controller and display characters. Such an example will be described below as a third embodiment.

### F 1. Controller Configuration:

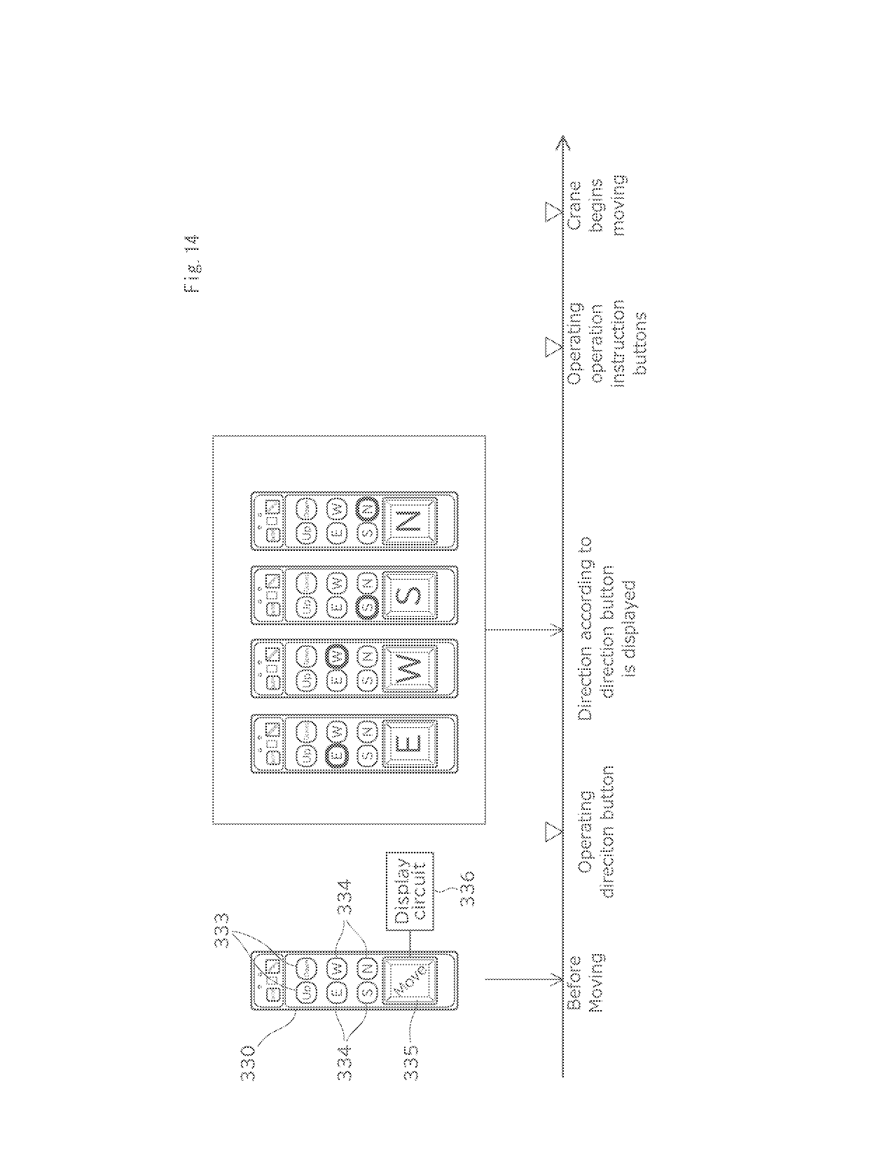

FIG. 14 is an explanatory diagram showing the configuration of the controller 330 in the third embodiment. As shown in the figure, the controller 330 of the third embodiment is provided with push buttons 333 for instructing winding up and winding down of the wire, push buttons 334 (also called a direction button) for instructing the direction of movement, and a push button 335 (also called a movement start button) for instructing the start of movement. The surface of the movement start button 335 is a display capable of displaying characters. The controller 330 includes a display circuit 336 for controlling this display.

The layout, size, etc. of the push buttons 333, 334, and 335 can be determined arbitrarily. Furthermore, in the controller 330 of the third embodiment, instead of the four direction buttons 334, the direction of movement may be specified by rotating the controller itself around the central axis of the cylindrical housing. The figure also shows how the display of the movement start button 335 in the third embodiment changes. Before the hoist 120 starts moving, the movement start button 335 displays the characters "Move" indicating that it is a button for instructing the start of movement.

Thereafter, when the operator presses one of the direction buttons 334 to specify a movement direction, the movement start button 335 displays the direction corresponding to the direction button. As shown in the figure, when "East" is specified as the movement direction, "E"(East) is displayed on the movement start button 335. When west, south, or north is designated, the movement start button 335 displays W(west), S(south), or N(north), respectively. Since the movement direction is displayed on the movement start button 335, the operator can easily check the instruction he or she has performed, and can immediately notice the error when he or she has specified the wrong movement direction.

When the operator operates the movement start button 335 with the movement direction displayed on the movement start button 335 in this manner, the hoist 120 starts moving. After the movement has started, the display of the movement start button 335 may be switched to "Stop" so that it functions as a push button for instructing the movement to be stopped. A push button for stopping movement may be provided separately from the movement start button 335.

### F 2. Preview Display Mode Control Process:

As explained in FIG. 14, the display of the direction of movement indicated before the hoist 120 starts moving is called preview display, and the operation of the hoist 120 in this state is called preview display mode. The control process for the crane in the preview display mode will be described below.

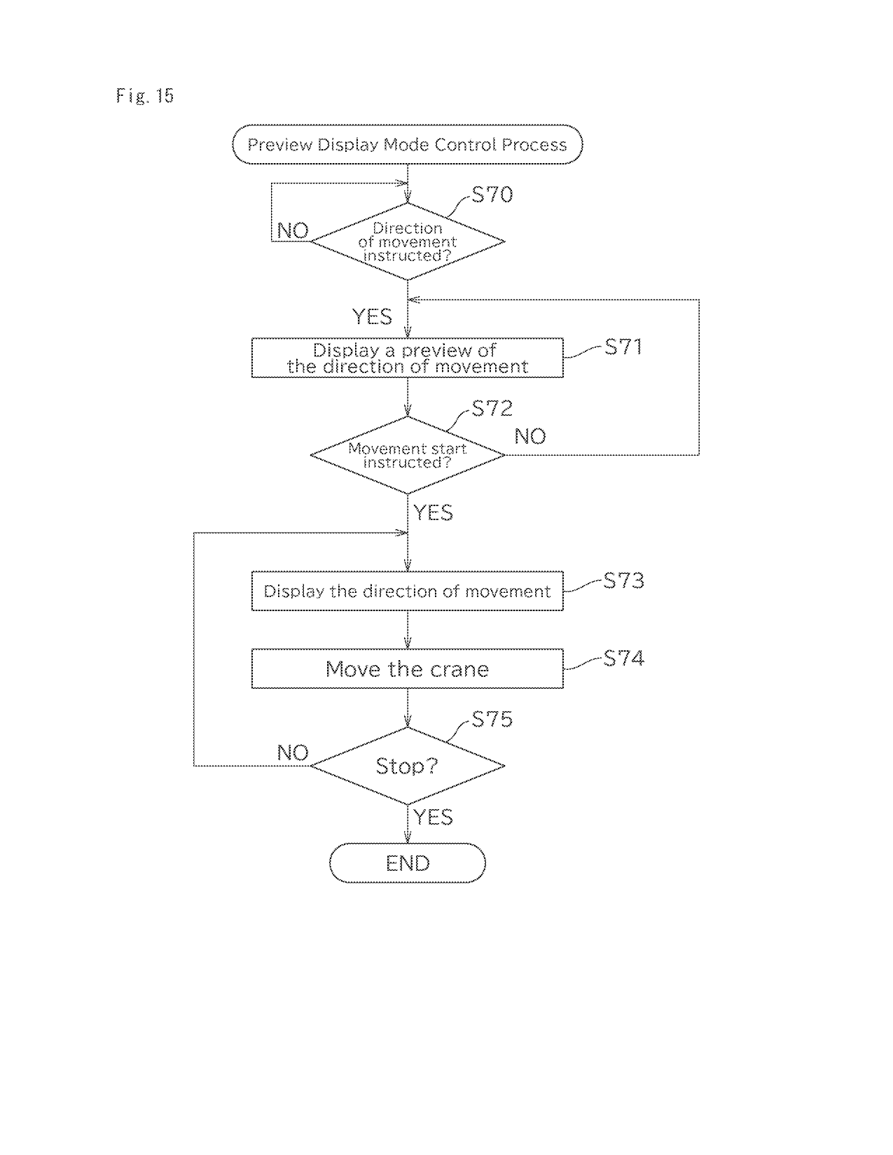

FIG. 15 is a flowchart of a preview display mode control process. This process is mainly executed by the crane movement control unit 143 (see FIG. 1), and in terms of hardware, it is executed by the CPU of the system control device 140.

When the process starts, the CPU waits until a direction of movement is instructed (Step S70), and when a direction of movement is instructed, displays a preview of the direction of movement (Step S71). As explained in FIG. 14, the characters indicating the instructed direction of movement are displayed on the movement start button 335 of the controller 330. In addition, an arrow indicating the direction of movement is displayed on a display device 123 provided on the hoist 120. The display of the movement start button 335 may not be performed

via the system control device 140, but may be performed by the display circuit 336 in the controller 330 detecting the operation of the direction button 334 and displaying the information accordingly. However, if the system control device 140 instructs the controller 330 on the direction of movement and causes the controller 330 to display the movement start button 335, and if the operation content of the direction button 334 is incorrectly transmitted to the system control device 140 due to the influence of noise or the like, the incorrect content will be displayed on the movement start button 335. This enables the operator to easily notice the error.

The CPU continues the preview display until the operator operates the movement start button 335 to instruct the start of movement (Step S72). When an instruction to start moving is given (Step S72), the CPU moves the crane (Step S74) while displaying the direction of movement on the display device 123 of the crane (Step S73). This movement continues until a stop command is issued (Step S75).

According to the third embodiment described above, the movement start button 335, which must be operated to move the hoist 120, displays a preview of the direction of movement, and the operator is forced to check this display, thereby improving safety. In addition, by having a preview display on the display device 123 as well, safety can be further improved.

### G. Fourth Embodiment:

In the third embodiment, an example was shown in which the surface of the movement start button 335 is used as a display, as an example in which the display also serves as an operation unit. Next, a fourth embodiment will be described in which a display is used to display multiple push buttons as an operation unit.

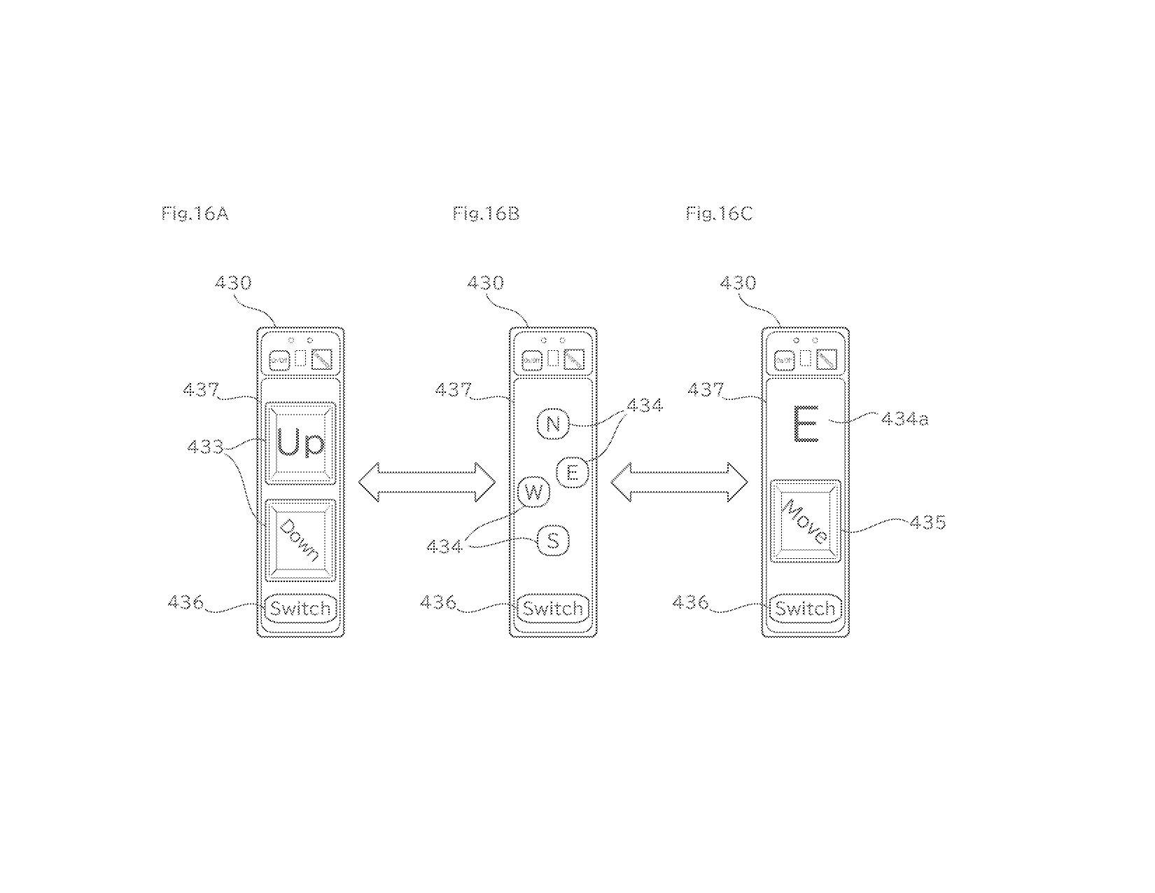

FIGS. 16A-16C are explanatory diagrams showing the configuration of the controller 430 in the fourth embodiment. A display 437 consisting of a touch panel is attached to the surface of the controller 430, and is capable of displaying push buttons according to the situation in which the crane is to be operated.

FIG. 16A shows an example of the screen of the display 437 when the hoist 120 is stopped. When stopped, push buttons 433 are displayed to instruct winding up or winding down of the wire. The screen display can be switched using a switch button 436.

FIG. 16B shows an example of the screen of the display 437 for instructing the direction of movement. On this screen, direction buttons 434 indicating the direction of movement and a switch button 436 for switching screens are displayed. The arrangement of the direction buttons 434 can be determined arbitrarily. In the example shown in the figure, the layout is aligned with the cardinal directions of north, south, east, and west. The east and west buttons are slightly offset up and down to avoid pressing the wrong button. The direction buttons 434 may change their position to display a heading depending on the direction in which the controller 430 is facing. This makes it possible to intuitively indicate the direction of movement.

When the movement direction is specified, the screen changes to that shown in FIG. 16C. On this screen, the instructed direction of movement 434a is displayed as a preview at the top of the display 437, and the movement start button 435 is displayed below it. The example shown in the figure is an example where movement to the east is displayed. By doing this, as explained in the third embodiment, the operator can check the preview display of the direction of movement before instructing to start moving, thereby improving safety. Instead of the characters "move" on the movement start button 435, the direction of movement may be displayed.

According to the fourth embodiment, an image corresponding to the scene of operating the crane can be displayed on the display 437 and used as an operation unit. For example, when the hoist 120 is being winded up or down, the image shown in FIG. 16A can be displayed to prevent the movement direction or movement start command from being given incorrectly. Furthermore, when the hoist 120 is to be moved, the images of FIGS. 16B and 16C can be displayed to prevent the hoist from being winded up or down by mistake. In this way, according to the fourth embodiment, misoperation can be prevented, improving safety.

In the fourth embodiment, the following modification may be adopted. The direction in which the controller 430 is pointed can be detected by a magnetic sensor or the like, and the direction in which the hoist 120 is to be moved can be indicated according to that direction.

At this time, the hoist 120 is not allowed to move freely in any direction, but is usually limited in its direction of movement to four or eight directions for safety reasons. Therefore, when the system control device detects the direction of the controller 430 using the magnetic sensor, it assigns one of the predefined directions using the same process as described with reference to FIG. 4. By doing so, even if the direction pointed by the controller 430 is slightly off from "North," it is possible to instruct movement to "North." The same applies to the other directions. It is possible to intuitively and easily specify the direction of movement without having to operate the movement direction button 434. Furthermore, if the hoist 120 were made movable in eight directions, eight movement directions 434 would be required, which would be very complicated. However, according to the above embodiment, the movement direction button 434 is not required, making it possible to avoid such complication.

When the direction of movement is specified in this way, the movement direction 434a is displayed on the controller 430 as shown in FIG. 16C. Therefore, the operator can confirm whether the direction of movement instructed by pointing the controller 430 has been properly accepted. Instead of the characters "Move" on the movement start button 435, the direction of movement may be displayed.

In the fourth embodiment, the display content of the movement direction button 434 may be changed depending on the direction in which the controller 430 is pointed. For example, when the crane can move in eight directions, and if the controller 430 is facing "North," it displays three movement direction buttons centered on "North": "Northwest" and "Northeast," or five buttons including "East" and "West." In this way, only some of the movement direction buttons centered on the direction in which the controller 430 is facing are displayed. This avoids the clutter caused by displaying a large number of movement direction buttons, while still providing the advantage of being able to reliably specify the direction of movement by operating the movement direction button. In this case too, the movement direction 434a as shown in FIG. 16C may be displayed in response to the operation of the movement direction button.

### H. Effects and Examples of Variations:

Various embodiments of the present invention have been described above. According to the present invention, by displaying various information on a display attached to a controller, it is possible to improve the safety of crane operation. It is not necessary to have all of the various features described in the above embodiments, and some of them may be omitted or combined as appropriate.

Furthermore, in addition to the embodiments, various modifications of the present invention can be made. In the embodiments, a crane for transporting a load within a facility has been exemplified, but the present invention can be used for various types of cranes, and may also be applied to a patient lift for transporting patients in a care facility. In addition, various modifications are possible. The present invention can be used to improve safety in crane operation.

What is claimed is:

1. A crane system comprising:
a crane device for lifting and moving a load;
a controller to be operated by an operator to control a movement of the crane device;
a display unit attached to the controller, configured to display information about the crane device in a form of text and/or image;
a detection unit that detects a direction in which the display unit is facing; and
a display control unit that controls the display unit to display the information according to the direction of the display unit.

2. The crane system according to claim 1,
wherein the display control unit acquires an operation of the controller and causes the display unit to perform a display corresponding to the operation.

3. The crane system according to claim 1,
wherein the detection unit includes a sensor for detecting an orientation of the display unit, and the detection unit outputs the direction of the display unit by assigning a sensor output to a closest predetermined direction among a set of predetermined directions.

4. The crane system according to claim 1,
wherein the detection unit includes a sensor for detecting an orientation of the display unit, and the detection unit outputs the direction of the display unit by correcting a sensor output with a predetermined correction value.

5. The crane system according to claim 4,
wherein the predetermined correction value is a value set based on an error between a direction set in a facility in which the crane system is installed and the orientation detected by the sensor.

6. The crane system according to claim 1,
wherein the detection unit detects a direction marker installed inside a facility in which the crane system is installed, the direction marker indicating a direction,
and wherein the detection unit identifies the direction of the display unit based on the direction marker.

7. The crane system according to claim 1,
wherein the display control unit causes the display unit to display a direction of movement of the crane device in a manner corresponding to the direction of the display unit.

8. The crane system according to claim 7,
wherein the display control unit displays on the display unit an image showing a state of an interior of a facility in which the crane system is installed and an image showing the direction of movement of the crane device superimposed on each other.

9. The crane system according to claim 7,
wherein the display control unit further causes the display unit to perform a display according to an inclination of the display unit with respect to a horizontal plane.

10. The crane system according to claim 1,
wherein the display control unit, when it is determined that a danger has occurred, causes the display unit to display a message to notify the operator operating the controller of the danger.

11. The crane system according to claim 1,
wherein the display control unit causes the display unit to display a position of a person or object other than the operator operating the controller.

12. The crane system according to claim 1,
wherein the crane device has a camera that captures the load from above,
and wherein the display control unit displays an image captured by the camera on the display unit.

13. The crane system according to claim 1,
wherein the controller is further capable of outputting a sound.

14. A non-transitory computer readable medium which stores a computer program for displaying information about the crane device on a mobile terminal in a crane system, the crane system including: a crane device for lifting and moving a load, a controller to be operated by an operator to control a movement of the crane device, and a system control device that controls the crane device in accordance with the operation of the controller,
wherein the computer program realizes:
an acquisition function for acquiring information about the crane device from the system control device;
a detection function for detecting a direction in which the display unit is facing; and
a display function for displaying the information according to the direction of the display unit.
